(19) United States
(12) Patent Application Publication
(10) Pub. No.: US 2017/0048924 A1
(43) Pub. Date: Feb. 16, 2017

(54) MULTIPLE BROADBAND SUBSCRIPTION SHARING

(71) Applicant: QUALCOMM Incorporated, San Diego, CA (US)

(72) Inventors: Amit Mate, Bangalore (IN); Senthil Kumar Govindaswamy, Bangalore (IN); Dhananjay Ashok Gore, Bangalore (IN); Ajit Venkat Rao, Bangalore (IN)

(21) Appl. No.: 14/822,658

(22) Filed: Aug. 10, 2015

(51) Int. Cl. H04W 84/12; H04L 12/46; H04L 29/12; H04L 12/28

(52) U.S. Cl. CPC H04W 84/12; H04L 12/2801; H04L 12/462; H04L 61/2007; H04L 61/256

(57) ABSTRACT

In various aspects, the disclosure provides for aggregating bandwidth in broadband subscription services including sending a query to a device and determining that the device is a bridging device; receiving a sharing profile from the bridging device; and routing a first data generated by a local area network (LAN) client to an external network over at least the bridging device using the sharing profile or over a backhaul link; and, in various aspects, further including receiving a second data from the external network over at least the bridging device using the sharing profile or over the backhaul link, wherein the second data is received in response to the first data; and routing the second data to the LAN client.

### TECHNICAL FIELD

Aspects of the present disclosure relate generally to wireless communication systems, and more particularly, to systems and methods for providing multiple broadband subscription sharing.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. Wireless communication networks may include both local area networks (LANs) and wide area networks (WANs). LAN may be useful to interconnect a plurality of user devices within a confined area such as a home or a workplace. LANs typically have very high throughput, low latency and high availability. However, LANs by themselves lack access to other (e.g., external) networks. Although WANs allow user device access to external networks, WANs are typically limited in throughput.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

According to various aspects, a method for aggregating bandwidth in broadband subscription services including sending a query to a device and determining that the device is a bridging device; receiving a sharing profile from the bridging device; and routing a first data generated by a local area network (LAN) client to an external network over at least the bridging device using the sharing profile or over a backhaul link. In various aspects, the method further includes receiving a second data from the external network over at least the bridging device using the sharing profile or over the backhaul link, wherein the second data is received in response to the first data; and routing the second data to the LAN client.

According to various aspects, a method for aggregating bandwidth in broadband subscription services including replying to a query that a bridging device has access to a wide area network (WAN) and is willing to share a wide area network (WAN) bandwidth with another device; sending at least one sharing profile of the bridging device; receiving a first data from a local area network (LAN) client, wherein the first data is destined for an external network; updating a sender IP address for the first data to generate an updated sender IP address; and routing the first data to the external network using the updated sender IP address. In various examples, the method further includes receiving a second data from the external network, wherein the second data is received in response to the first data; updating a receiver IP address for the second data to generate an updated receiver IP address; and routing the second data using the updated receiver IP address.

According to various aspects, An apparatus for aggregating bandwidth in broadband subscription services including an egress module configured for sending a query to a device; a processor coupled to the egress module, wherein the processor is configured for determining that the device is a bridging device; an ingress module coupled to the processor, wherein the ingress module is configured for receiving a sharing profile from the bridging device; and a router, coupled to the ingress module, wherein the router is configured for routing a first data generated by a local area network (LAN) client to an external network over at least the bridging device using the sharing profile or over a backhaul link. In various aspects, the ingress module is further configured for receiving a second data from the external network over at least the bridging device using the sharing profile or over the backhaul link, wherein the second data is received in response to the first data; and the router is further configured for routing the second data to the LAN client.

According to various aspects, an apparatus for aggregating bandwidth in broadband subscription services including an ingress module configured for replying to a query that a bridging device has access to a wide area network (WAN) and is willing to share a wide area network (WAN) bandwidth with another device, and for receiving a first data from a local area network (LAN) client, wherein the first data is destined for an external network; an egress module coupled to the ingress module, wherein the egress module is configured for sending at least one sharing profile of the bridging device; a processor coupled to the ingress module, wherein the processor is configured for updating a sender IP address for the first data to generate an updated sender IP address; and a router coupled to the ingress module, wherein the router is configured for routing the first data to the external network using the updated sender IP address. In various aspects, the ingress module is further configured for receiving a second data from the external network, wherein the second data is received in response to the first data; the processor is further configured for updating a receiver IP address for the second data to generate an updated receiver IP address; and the router is further configured for routing the second data using the updated receiver IP address.

According to various aspects, an apparatus for aggregating bandwidth in broadband subscription services including means for sending a query to a device and determining that the device is a bridging device; means for receiving a sharing profile from the bridging device; and means for routing a first data generated by a local area network (LAN) client to an external network over at least the bridging device using the sharing profile or over a backhaul link. In various aspects, the apparatus further includes means for receiving a second data from the external network over at least the bridging device using the sharing profile or over the backhaul link, wherein the second data is received in response to the first data; and means for routing the second data to the LAN client.

According to various aspects, an apparatus for aggregating bandwidth in broadband subscription services including means for replying to a query that a bridging device has access to a wide area network (WAN) and is willing to share a wide area network (WAN) bandwidth with another device; means for sending at feast one sharing profile of the bridging device; means for receiving a first data from a local area network (LAN) client, wherein the first data is destined for an external network; means for updating a sender IP address for the first data to generate an updated sender IP address; and means for routing the first data to the external network using the updated sender IP address. In various aspects, the apparatus further includes means for receiving a second data from the external network, wherein the second data is received in response to the first data; means for updating a receiver IP address for the second data to generate an updated receiver IP address; and means for routing the second data using the updated receiver IP address.

According to various aspects, a computer-readable storage medium storing computer executable code, operable on a device including at least one processor; a memory for storing a sharing profile, the memory coupled to the at least one processor; and the computer executable code including instructions for causing the at least one processor to send a query to a device; instructions for causing the at least one processor to determine that the device is a bridging device; instructions for causing the at least one processor to receive the sharing profile from the bridging device; and instructions for causing the at least one processor to route a first data generated by a local area network (LAN) client to an external network over at least the bridging device using the sharing profile or over a backhaul link. In various aspects, the stored computer executable code further includes instructions for causing the at least one processor to receive a second data from the external network over at least the bridging device using the sharing profile or over the backhaul link, wherein the second data is received in response to the first data; and instructions for causing the at least one processor to route the second data to the LAN client.

According to various aspects, a computer-readable storage medium storing computer executable code, operable on a device including at least one processor; a memory for storing a sender IP address, the memory coupled to the at least one processor; and the computer executable code including instructions for causing the at least one processor to reply to a query that a bridging device has access to a wide area network (WAN) and is willing to share a wide area network (WAN) bandwidth with another device; instructions for causing the at least one processor to send at least one sharing profile of the bridging device; instructions for causing the at least one processor to receive a first data from a local area network (LAN) client, wherein the first data is destined for an external network; instructions for causing the at least one processor to update the sender IP address for the first data to generate an updated sender IP address; and instructions for causing the at least one processor to route the first data to the external network using the updated sender IP address.

### BRIEF DESCRIPTION OF THE DRAWINGS

FIG. 1 is a conceptual diagram illustrating an example communication system including a first communication device capable of communicating in both wide area network (WAN) and wireless local area network (WLAN) in accordance with aspects of the present disclosure.

FIG. 2a is a conceptual diagram illustrating a first example of a telecommunications system in accordance with aspects of the present disclosure.

FIG. 2b is a conceptual diagram illustrating a second example of a telecommunications system in accordance with aspects of the present disclosure.

FIG. 3 is a conceptual diagram illustrating a second example of a telecommunications system in accordance with aspects of the present disclosure.

FIG. 4 illustrates an example of an access network in accordance with aspects of the present disclosure.

FIG. 5 illustrates an example of a base station in communication with a user equipment in a networking system in accordance with aspects of the present disclosure.

FIG. 6 illustrates an example of a home or workplace network with multiple user devices each with local area network (LAN) access (e.g.. via WiFi) which use a single home router for WAN access.

FIG. 7 illustrates a first example of a broadband subscription system where additional WAN access throughput is attained by aggregating WAN access from various user devices in accordance with aspects of the present disclosure.

FIG. 8 illustrates a second example of a broadband subscription system where additional WAN access throughput is attained by aggregating WAN access from various user devices in accordance with aspects of the present disclosure.

FIG. 9 illustrates a third example of a broadband subscription system where additional WAN access throughput is attained by aggregating WAN access from various user devices in accordance with aspects of the present disclosure.

FIG. 10 illustrates an example protocol stack for cellular routing in broadband subscription aggregation in accordance with aspects of the present disclosure.

FIG. 11 illustrates an example protocol stack for Digital Subscriber Line (DSL) routing in broadband subscription aggregation in accordance with aspects of the present disclosure.

FIG. 12 illustrates an example data flow for a simultaneous download of video content by a plurality of LAN clients in accordance with aspects of the present disclosure.

FIG. 13 illustrates an example data flow for a simultaneous download of video content email attachment file and image file by a single LAN client in accordance with aspects of the present disclosure.

FIG. 14 illustrates an example data flow for a single connection over multiple subscription links by a LAN client in accordance with aspects of the present disclosure.

FIG. 15 illustrates an example aggregation and bridging protocol with interaction between an aggregator device and a bridging device in accordance with aspects of the present disclosure.

FIG. 16 illustrates a first example flow diagram for aggregating bandwidth in broadband subscription services in accordance with aspects of the present disclosure.

FIG. 17 illustrates a second example flow diagram for aggregating bandwidth in broadband subscription services in accordance with aspects of the present disclosure.

FIG. 18 is a conceptual diagram 1800 illustrating a simplified example of a hardware implementation for an apparatus employing a processing circuit 1802 that may be configured to perform one or more functions in accordance with aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to a void obscuring such concepts.

In a wireless communication network that combines a local area network (LAN) and a wide area network (WAN), mutual benefits may be gained. LANs are useful for interconnecting multiple user devices within a defined area. LANs have high throughput, high availability and low latency. LANs may lack access to other external networks. WANs may lack high throughput, but WANs allow user device access to external networks over a large geographic reach. Thus, by combining LANs and WANs, the benefits that each of the networks bring to the other may work together to overcome any deficiencies in the other network. Thus, by interconnecting a LAN with a WAN, for example, by using routers or other network bridging devices, the interconnect may allow for higher throughput and greater access to external networks. Various aspects of the present disclosure which include the interconnection of a LAN with a WAN may allow for an efficient utilization of the LAN and WAN by enabling an improvement of user device performance.

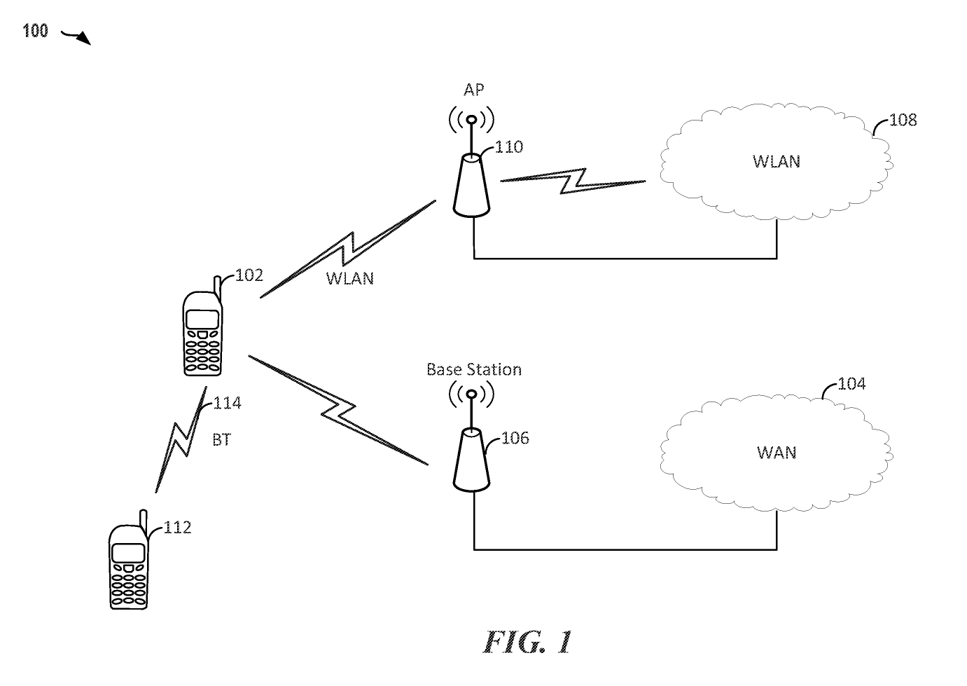

FIG. 1 is a conceptual diagram illustrating an example communication system including a first communication device capable of communicating in both a wide area network (WAN) and a wireless local area network (WLAN) in accordance with aspects of the present disclosure. Referring to FIG. 1, a communication device 102 is configured to communicate on a wide area network (WAN) 104 through a base station (BS) 106, and a WLAN 108 through an access point (AP) 110. In an aspect of the disclosure, the WAN may be a Universal Mobile Telecommunications System (UMTS) network, a CDMA2000 network or any other suitable WAN. In an aspect of the disclosure, the WLAN 108 employs widely used networking protocols such as the IEEE 802.11 wireless protocol family (WiFi).

In addition, a second communication device 112 may connect to communication device 102 via a short-range wireless link 114, e.g., Bluetooth (BT). However, the present disclosure is not limited to the communication devices shown in FIG. 1. A non-exhaustive list of the communication devices 102 and 112 includes smartphone, smart watch, mobile phone, personal digital assistant, portable computer, tablet computer, desktop computer, digital printer, wireless speaker, multimedia player, digital camera, camcorder, smart television, digital video recorder, cable or satellite set top box, network card, etc.

In an aspect of the disclosure, the communication device 102 may be configured to simultaneously communicate with other devices using both WLAN and WAN. For example, the first communication device 102 may simultaneously communicate with the AP 110 and the second communication device 112 using WLAN and WAN connections, respectively.

The various concepts presented throughout this disclosure may be applicable to a broad variety of telecommunication systems, network architectures, and communication standards. In particular, a communication network range extension hub may receive messages from a client device that may be embodied in a mobile wireless communications device. The messages may be transmitted through packet data services obtained through a wireless access network, and through the Internet or another public or private data network.

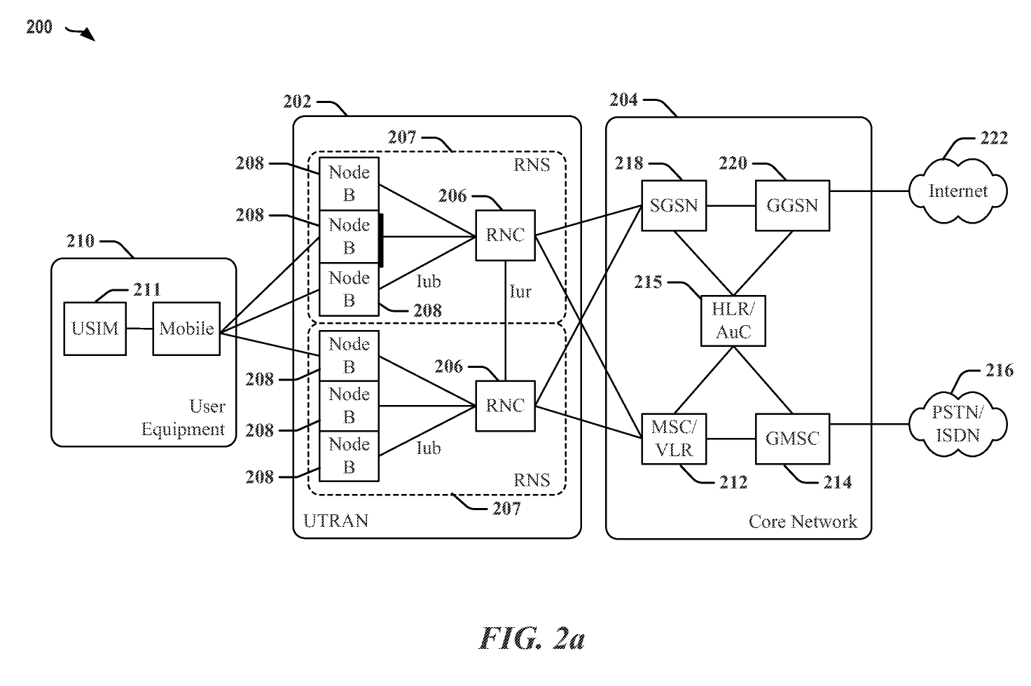

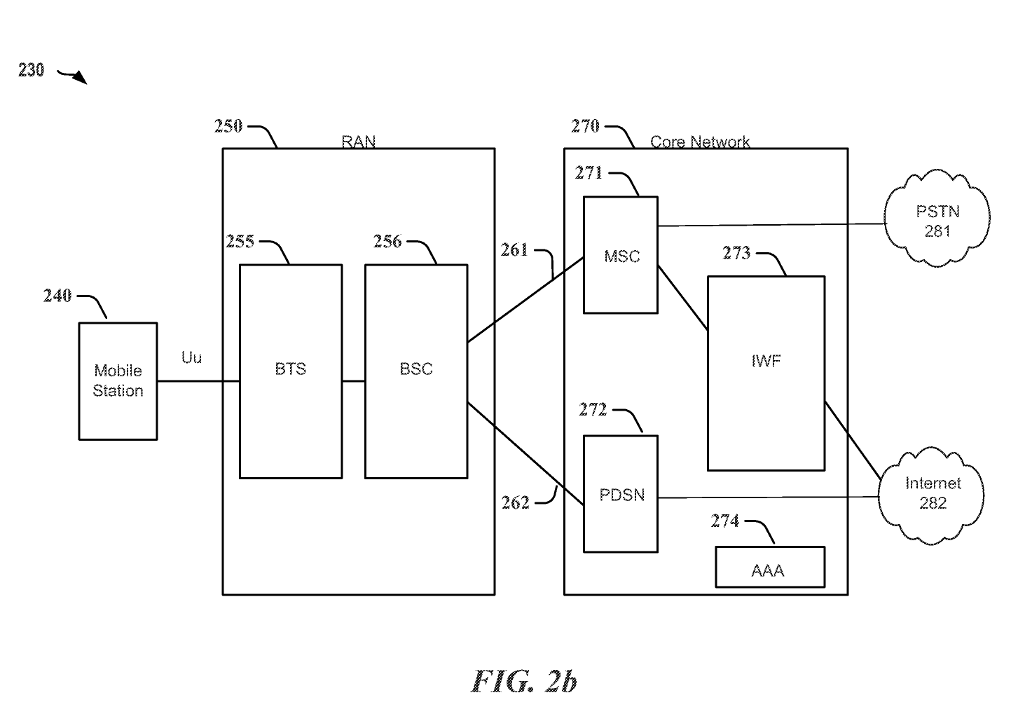

In various aspects, the user equipment (UE) may include dual modes of communication. FIG. 2a is a conceptual diagram illustrating a first example of a telecommunications system in accordance with aspects of the present disclosure. In FIG. 2a, one example of a wireless networking environment, among the various possible examples is illustrated. In the example depicted, various aspects of the present disclosure are illustrated for a WAN with reference to a Universal Mobile Telecommunications System (UMTS) 200. A UMTS 200 includes three interacting domains: a core network 204 (a.k.a. an external network from a UE perspective), a RAN (e.g., the UTRAN) 202, and a UE 210. Among several options available for the illustrated example, the UTRAN 202 may employ a W-CDMA air interface for enabling various wireless services including telephony, video, data, messaging, broadcasts, and/or other services. The UTRAN 202 may include a plurality of Radio Network Subsystems (RNSs) 207, each controlled by a respective Radio Network Controller (RNC) 206. Here, the UTRAN 202 may include any number of RNCs 206 and RNSs 207 in addition to the illustrated RNCs 206 and RNSs 207. The RNC 206 is an apparatus responsible for, among other things, assigning, reconfiguring, and releasing radio resources within the RNS 207. The RNC 206 may be interconnected to other RNCs (not shown) in the UTRAN 202 through various types of interfaces such as a direct physical connection, a virtual network, or the like using any suitable transport network.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each depicted RNS 207; however, the RNSs 207 may include any number of wireless Node Bs 208. The Node Bs 208 provide wireless access points to a core network 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, a wearable computing device (e.g., a smartwatch, a health or fitness tracker, etc.), an appliance, a sensor, a vending machine, a smart television, a digital video recorder, a cable or satellite set top box, or any other similar functioning device.

The mobile apparatus is commonly referred to as user equipment or UE 210 in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS, the UE 210 may further include a universal subscriber identity module (USIM) 211, which contains a user's subscription information to a network. The UE 210 may include a plurality of USIMs 211. For illustrative purposes, one UE 210 is shown in communication with a number of the Node Bs 208. The downlink (DL), also called the forward link, refers to the communication link from a Node B 208 to a UE 210 and the uplink (UL), also called the reverse link, refers to the communication link from a UE 210 to a Node B 208.

The core network 204 can interface with one or more access networks, such as the UTRAN 202. As shown, the core network 204 is a UMTS core network. However, as those skilled in the art will recognize, the various concepts presented throughout this disclosure may be implemented in a RAN, or other suitable access network, to provide UEs 210 with access to types of core networks other than UMTS core networks 204.

The illustrated UMTS core network 204 includes a circuit-switched (CS) domain and a packet-switched (PS) domain. Some of the circuit-switched elements are a Mobile Switching Center (MSC), a Visitor Location Register (VLR), and a Gateway MSC (GMSC). Packet-switched elements include a Serving GPRS Support Node (SGSN) and a Gateway GPRS Support Node (GGSN). Some network elements, such as Equipment Identity Register (EIR), a VLR, a home location register (HLR), and/or an authentication center (AuC) may be shared by both of the circuit-switched and packet-switched domains.

In the illustrated example, the core network 204 supports circuit-switched services with a MSC 212 and a GMSC 214. In some applications, the GMSC 214 may be referred to as a media gateway (MGW). One or more RNCs 206 may be connected to the MSC 212. The MSC 212. is an apparatus that controls call setup, call routing, and UE mobility functions. The MSC 212 also includes a VLR that contains subscriber-related information for the duration that a UE 210 is in the coverage area of the MSC 212. The GMSC 214 provides a gateway through the MSC 212 for the UE 210 to access a circuit-switched network 216. The GMSC 214 includes an HLR 215 containing subscriber data, such as the data reflecting the details of the services to which a particular user has subscribed. The HLR 215 is also associated with an AuC that contains subscriber-specific authentication data. When a call is received for a particular UE 210, the GMSC 214 queries the HLR 215 to determine the location of the UE 210 and forwards the call to the particular MSC 212 serving that location.

The illustrated core network 204 also supports packet-switched data services with a serving GPRS support node (SGSN) 218 and a gateway GPRS support node (GGSN) 220. General Packet Radio Service (GPRS) is designed to provide packet-data services at speeds higher than those available with standard circuit-switched data services. The GGSN 220 provides a connection for the UTRAN 202 to a packet-based network 222 (e.g., Internet). The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

The UTRAN air interface may be a spread spectrum Direct-Sequence Code Division Multiple Access (DS-CDMA) system, such as one utilizing the W-CDMA standards. The spread spectrum DS-CDMA spreads user data through multiplication by a sequence of pseudorandom bits called chips. The W-CDMA air interface for the UTRAN 202 is based on such DS-CDMA technology and additionally calls for a frequency division duplexing (FDD). FDD uses a different carrier frequency for the uplink (UL) and downlink (DL) between a Node B 208 and a UE 210. Another air interface for UMTS that utilizes DS-CDMA, and uses time division duplexing (TDD), is the TD-SCDMA air interface. Those skilled in the art will recognize that although various examples described herein may refer to a W-CDMA air interface, the underlying principles are equally applicable to a TD-SCDMA air interface or any other suitable air interface.

The UTRAN 202 is but one example of a RAN that may be utilized in accordance with the present disclosure. Other examples may include Long Term Evolution (LTE), which provides a set of enhancements to the UMTS mobile standard promulgated by the 3GPP.

FIG. 2b is a conceptual diagram illustrating a second example of a telecommunications system in accordance with aspects of the present disclosure. In FIG. 2b, various aspects of the present disclosure are illustrated for a wide area network (WAN) with reference to an Evolution Data Only (EVDO) system 230 as part of the 3GPP2 protocol family. The EVDO system 230 includes three interacting domains: a core network 270, a RAN 250 and a mobile station (MS) 240. The RAN 250 may include a plurality of Base Transceiver Systems (BTS) 255, each controlled by a respective Base Station Controller (BSC) 256. The RAN 250 may include any number of BTSs 255 and BSCs 256 in addition to the illustrated BTS 255 and BSC 256. The BSC 256 may be responsible for radio resource management within the BTS 255.

The geographic region covered by the BTS 255 may be divided into a number of cells, with a radio transceiver apparatus serving each cell, also known as a base station (BS). The BTS 255 may provide radio access to the core network 270 for any number of mobile stations (MS) 240. The MS 240 is also referred to as user equipment (UE). For illustration, in FIG. 2b, one MS 240 is shown in communication with a BTS 255 over a Uu interface. The downlink (DL), also known as forward link, refers to the communication link from a BTS 255 to a MS 240. The uplink (UL), also known as reverse link, refers to the communication link from a MS 240 to a BTS 255.

The core network 270 may interface with one or more access networks, such as the RAN 250. As shown, the core network 270 is an EVDO core network. However, the various concepts presented here may be implemented by any suitable access network to provide the MS 240 with access to other core networks.

The core network 270 may include a circuit switched interface 261 and a packet switched interface 262 from the RAN 250. Circuit switched services are handled by mobile switching center (MSC) 271 and packet switched services are handled by packet data serving node (PDSN) 272. The MSC 271 may connect to a public switched telephony network (PSTN) 281 or any other circuit switched network. The PDSN 272 may connect to the Internet 282 or any other packet switched network. In addition, the core network 270 may provide an inter-working function (IWF) 273 to facilitate cross-domain connectivity between MSC 271 and the Internet 282. Also, an authentication authorization and accounting (AAA) server 274 provides various security services in the core network 270.

The RAN 250 air interface may be a spread spectrum Code Division Multiple Access (CDMA) system which may use a variety of wireless access standards such as the cdma 2000 family. Although various examples described herein may refer to a CDMA air interface, the underlying principles are equally applicable to any suitable air interface.

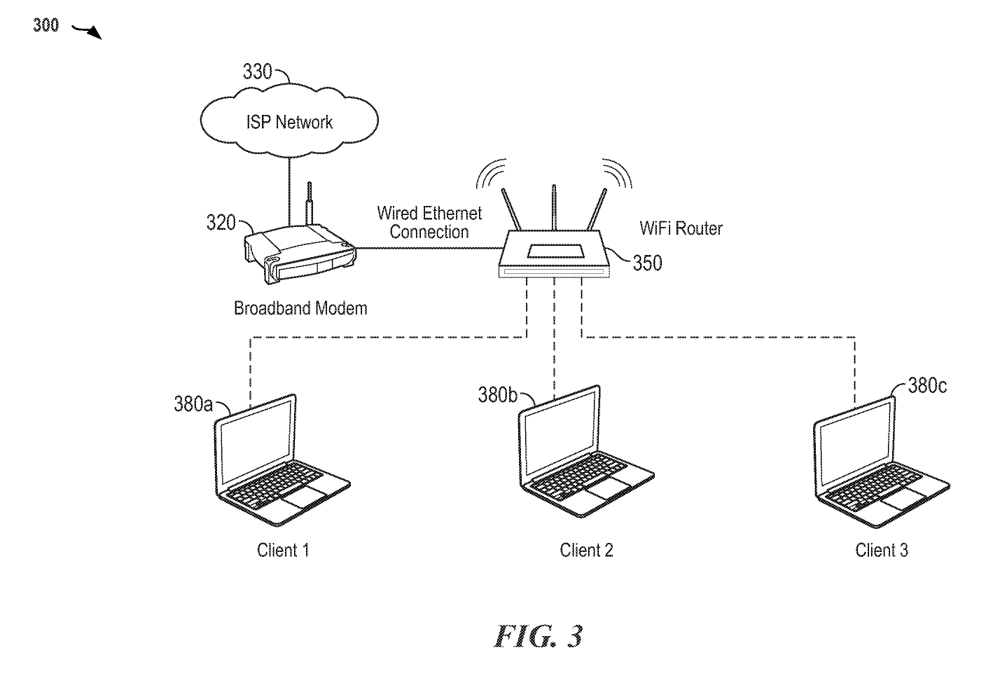

FIG. 3 is a conceptual diagram illustrating a second example of a telecommunications system in accordance with aspects of the present disclosure. In FIG. 3, another example of a wireless networking environment, among the various possible examples is illustrated. FIG. 3 illustrates an example wireless LAN architecture 300, based on IEEE protocol 802.11, also known as WiFi. WLANs may operate in different frequency bands, for example 2.4 GHz and 5.0 GHz, where each frequency band is further partitioned into a plurality of WLAN channels. WiFi may be employed to provide LAN access to user devices within range of the WiFi network.

In various examples, a plurality of clients 380 (e.g., user devices 380a, 380b, 380c, etc.) connect to an access point (AP) 350 which may be further connected to a broadband modem 320 which has WAN access to an external network 330 (e.g. an Internet service provider (ISP)). For example, the AP 350 may be a WiFi router or other network bridging device. An AP 350 may interconnect a plurality of user devices 380 to another network device 340 (not shown), such as a network hub, switch or router, which may in turn access other networks. In various examples, the AP 350 may be a router or may be an integrated network device which incorporates a wireless access point, an Ethernet switch and an external network router using compatible network protocols. One skilled in the art would understand that the examples of wireless access points listed herein are not exclusive and that other examples may be used within the spirit and scope of the present disclosure.

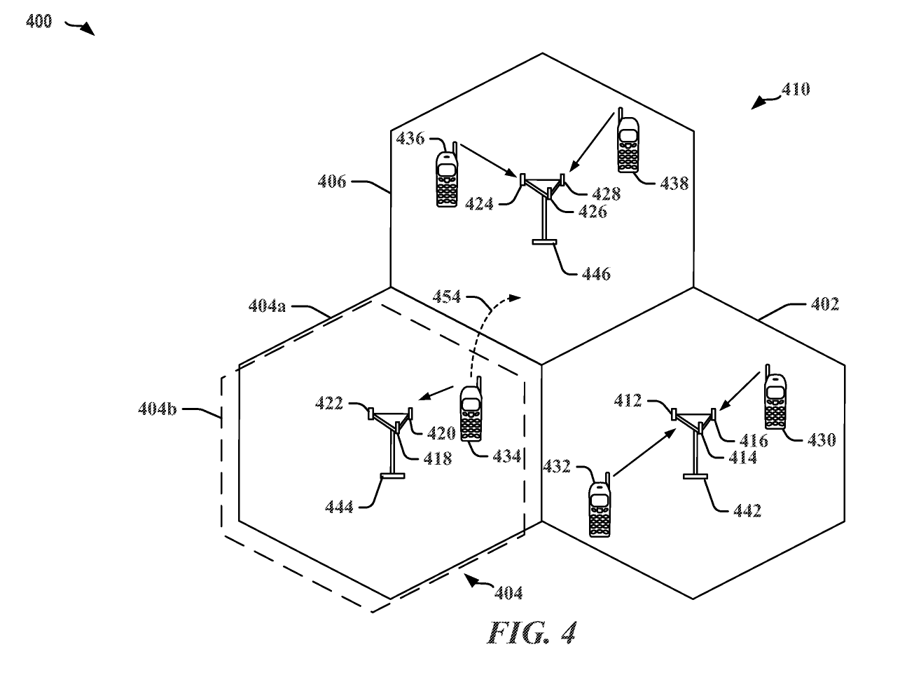

Referring to FIG. 4, by way of example and without limitation, a simplified schematic illustration of a networking environment 400 that includes RAN 410 that may be implemented as a UTRAN, E-UTRAN, or other such architecture. The RAN 410 may include multiple cellular regions (cells), including cells 402, 404, and 406, each of which may include one or more sectors. Cells may be defined geographically (e.g., by coverage area) and/or may be defined in accordance with a frequency, scrambling code, etc. That is, the illustrated geographically-defined cells 402, 404, and 406 may each be further divided into a plurality of cells, e.g., by utilizing different scrambling codes. For example, cell 404a may utilize a first scrambling code, and cell 404b, while in the same geographic region and served by the same base station 444, may be distinguished by utilizing a second scrambling code. In one example, the base stations 442, 444 and 446 may operate as the Node B 208 of FIG. 2a.

In a cell that is divided into sectors, the multiple sectors within a cell can be formed by groups of antennas with each antenna responsible for communication with UEs in a portion of the cell. For example, in cell 402, antenna groups 412, 414, and 416 may each correspond to a different sector. In cell 404, antenna groups 418, 420, and 422 may each correspond to a different sector. In cell 406, antenna groups 424, 426, and 428 may each correspond to a different sector.

The cells 402, 404, and 406 may include several UEs that may be in communication with one or more sectors of each cell 402, 404, or 406. For example, UEs 430 and 432 may be in communication with base station 442, UE 434 may be in communication with base station 444, and UEs 436 and 438 may be in communication with base station 446. Here, each base station 442, 444, and 446 may be configured to provide an access point to a core network 204 (see FIG. 2a) for all the UEs 430, 432, 434, 436, and 438 in the respective cells 402, 404, and 406.

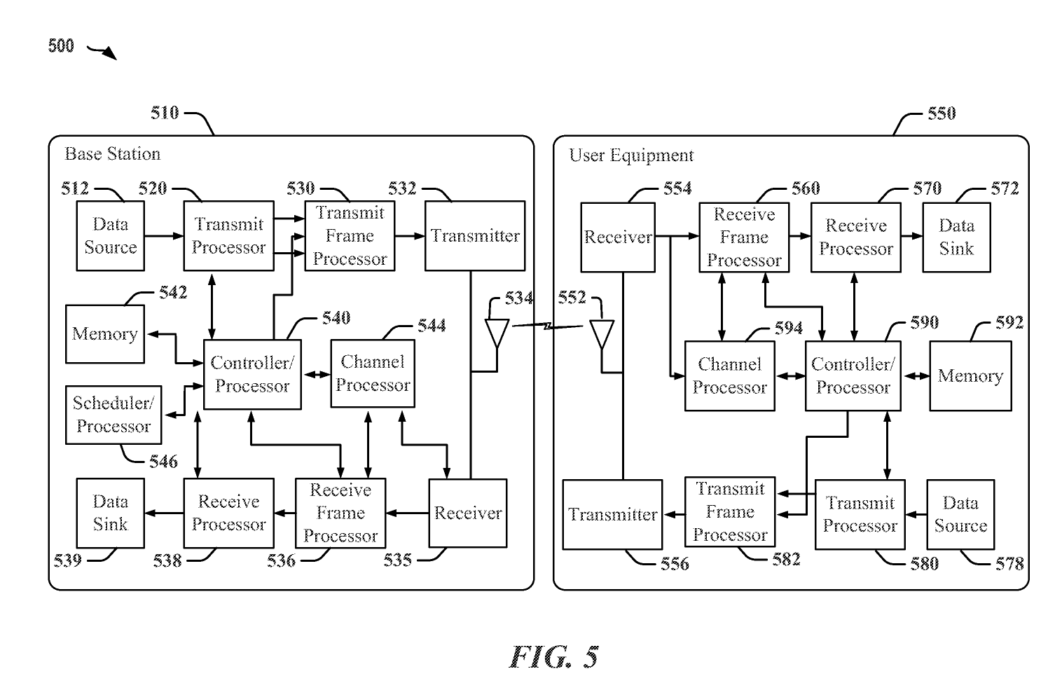

FIG. 5 is a block diagram illustrating an example of a base station 510 in communication with a UE 550, where the base station 510 may be the base station 208 in FIG. 2a, and the UE 550 may be the UE 210 in FIG. 2a. Each of the base station 510 and the UE 550 may include one or more processing circuits such as the processing circuit 102 of FIG. 1. In the downlink communication, a transmit processor 520 of the base station 510 may receive data from a data source 512 and control signals from a controller/processor 540. The transmit processor 520 provides various signal processing functions for the data and control signals, as well as reference signals (e.g., pilot signals). For example, the transmit processor 520 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 544 may be used by the controller/processor 540 to determine the coding, modulation, spreading, and/or scrambling schemes for the transmit processor 520. These channel estimates may be derived from a reference signal transmitted by the UE 550 or from feedback from the UE 550. The symbols generated by the transmit processor 520 are provided to a transmit frame processor 530 to create a frame structure. The transmit frame processor 530 creates this frame structure by multiplexing the symbols with information from the controller/processor 540, resulting in a series of frames. The frames are then provided to a transmitter 532, which provides various signal conditioning functions including amplifying, filtering, and modulating the frames onto a carrier for downlink transmission over the wireless medium through antenna 534. The antenna 534 may include one or more antennas, for example, including beam steering bidirectional adaptive antenna arrays or other similar beam technologies.

At the UE 550, a receiver 554 receives the downlink transmission through an antenna 552 and processes the transmission to recover the information modulated onto the carrier. The information recovered by the receiver 554 is provided to a receive frame processor 560, which parses each frame, and provides information from the frames to a channel processor 594 and the data, control, and reference signals to a receive processor 570. The receive processor 570 then performs the inverse of the processing performed by the transmit processor 520 in the base station 510. More specifically, the receive processor 570 descrambles and despreads the symbols, and then determines the most likely signal constellation points transmitted by the base station 510 based on the modulation scheme. These soft decisions may be based on channel estimates computed by the channel processor 594. The soft decisions are then decoded and deinterleaved to recover the data, control, and reference signals. The CRC codes are then checked to determine whether the frames were successfully decoded. The data carried by the successfully decoded frames will then be provided to a data sink 572, which represents applications running in the UE 550 and/or various user interfaces (e.g., a display). Control signals carried by successfully decoded frames are provided to a controller/processor 590. When frames are unsuccessfully decoded by the receiver processor 570, the controller/processor 590 may also use an acknowledgement (ACK) and/or negative acknowledgement (NACK) protocol to support retransmission requests for those frames.

In the uplink, data from a data source 578 in the UE 550, and control signals from the controller/processor 590 are provided to a transmit processor 580. The data source 578 may represent applications running in the UE 550 and various user interfaces (e.g., keyboard). Similar to the functionality described in connection with the downlink transmission by the base station 510, the transmit processor 580 provides various signal processing functions including CRC codes, coding and interleaving to facilitate FEC, mapping to signal constellations, spreading with OVSFs, and scrambling to produce a series of symbols. Channel estimates, derived by the channel processor 594 from a reference signal transmitted by the base station 510 or from feedback contained in a midamble transmitted by the base station 510, may be used to select the appropriate coding, modulation, spreading, and/or scrambling schemes. The symbols produced by the transmit processor 580 may be provided to a transmit frame processor 582 to create a frame structure. The transmit frame processor 582 creates this frame structure by multiplexing the symbols with information from the controller/processor 590, resulting in a series of frames. The frames are then provided to a transmitter 556, which provides various signal conditioning functions including amplification, filtering, and modulating the frames onto a carrier for uplink transmission over the wireless medium through the antenna 552.

The uplink transmission is processed at the base station 510 in a manner similar to that described in connection with the receiver function at the UE 550. A receiver 535 receives the uplink transmission through the antenna 534 and processes the transmission to recover the information modulated onto the carrier. The information recovered by the receiver 535 is provided to a receive frame processor 536, which parses each frame, and provides information from the frames to the channel processor 544 and the data, control, and reference signals to a receive processor 538. The receive processor 538 performs the inverse of the processing performed by the transmit processor 580 in the UE 550. The data and control signals carried by the successfully decoded frames may then be provided to a data sink 539 and the controller/processor, respectively. If some of the frames were unsuccessfully decoded by the receive processor, the controller/processor 540 may use an acknowledgement (ACK) and/or negative acknowledgement (NACK) protocol to support retransmission requests for those frames.

The controller/processors 540 and 590 may be used to direct the operation at the base station 510 and the UE 550, respectively. For example, the controller/processors 540 and 590 may provide various functions including timing, peripheral interfaces, voltage regulation, power management, and other control functions. The computer readable media of memories 542 and 592 may store data and software for the base station 510 and the UE 550, respectively. A scheduler/processor 546 at the base station 510 may be used to allocate resources to UEs and schedule downlink and uplink transmissions for the UEs.

In a wireless telecommunication system, the communication protocol architecture may take on various forms depending on the particular application. For example, in a 3GPP UMTS, the signaling protocol stack is divided into a Non-Access Stratum (NAS) and an Access Stratum (AS). The NAS provides the upper layers for signaling between the UE 210 and the core network 204 (referring to FIG. 2a), and may include circuit switched and packet switched protocols. The AS provides the lower layers for signaling between the UTRAN 202 and the UE 210, and may include a user plane and a control plane. Here, the user plane or data plane carries user traffic, while the control plane carries control information (i.e., signaling).

Certain aspects of the present disclosure relate to a UE 550 that is adapted to support communication technologies used for interfacing with other devices that are physically in close proximity to the UE 550. Examples of such communication technologies may be based on wireless technologies including technologies defined in WLAN standards (including the IEEE 802.11 standards for Wi-Fi networks), and wireless personal area network (WPAN) standards.

In various examples, a common telecommunications scenario is a home or workplace network where there are a plurality of user devices with both local area network (LAN) and wide area network (WAN) connections. The LAN may be used to interconnect user devices within a limited geographic area (e.g., home or workplace). The WAN may be used to access external networks or core networks, for example, the Internet. For example, the LAN connection may be implemented using WiFi, based on the IEEE 802.11 protocol standard, which may in turn access an external network, for example, the Internet, via a router. The user devices may also be denoted as LAN clients since these user devices access telecommunication services using a LAN for interconnection. The WAN connection may be implemented using a wireless broadband subscription service such as GSM, UMTS, LIE, cdma1x, cdma2000, etc. A user device having a broadband subscription service means that the user device has access to an external network (e.g., Internet, a public data network or a private data network.) via a service agreement. In various examples, the user device having the broadband subscription service may be a mobile device, a non-mobile device (i.e., a fixed device) or a portable device (i.e., a drone device).

In various examples, the WAN connection may be implemented using a variety of wireless technologies including time division multiple access (TDMA), code division multiple access (CDMA), frequency division multiple access (FDMA), orthogonal frequency division multiple access (OFDMA), etc. For example, the user device may be compatible with a plurality of wireless technologies to provide broader WAN access. Or the WAN connection may be implemented using a wired broadband subscription service such as Digital Subscriber Line (DSL), cable, fiber optic, etc.

The wireless or wired broadband subscription service may directly access the external or core network (e.g. Internet). In various examples, only one broadband subscription service for a WAN connection may be active in the home or workplace network even though other WAN connections may be available. Subscription aggregation is defined as the combination of individual broadband subscription services. Subscription aggregation of broadband subscription services in a home or workplace network may be beneficial to improve external network access, for example, Internet access, and to offer increased access throughput to user devices which access the Internet. In some examples, a broadband subscription service may also be known as a backhaul link.

In some instances, high bandwidth demand (i.e., high data throughput requirements) from a single user device may degrade the overall data throughput in a home or workplace network. This throughput degradation may be due to the usage of a single shared broadband subscription service among several user devices.

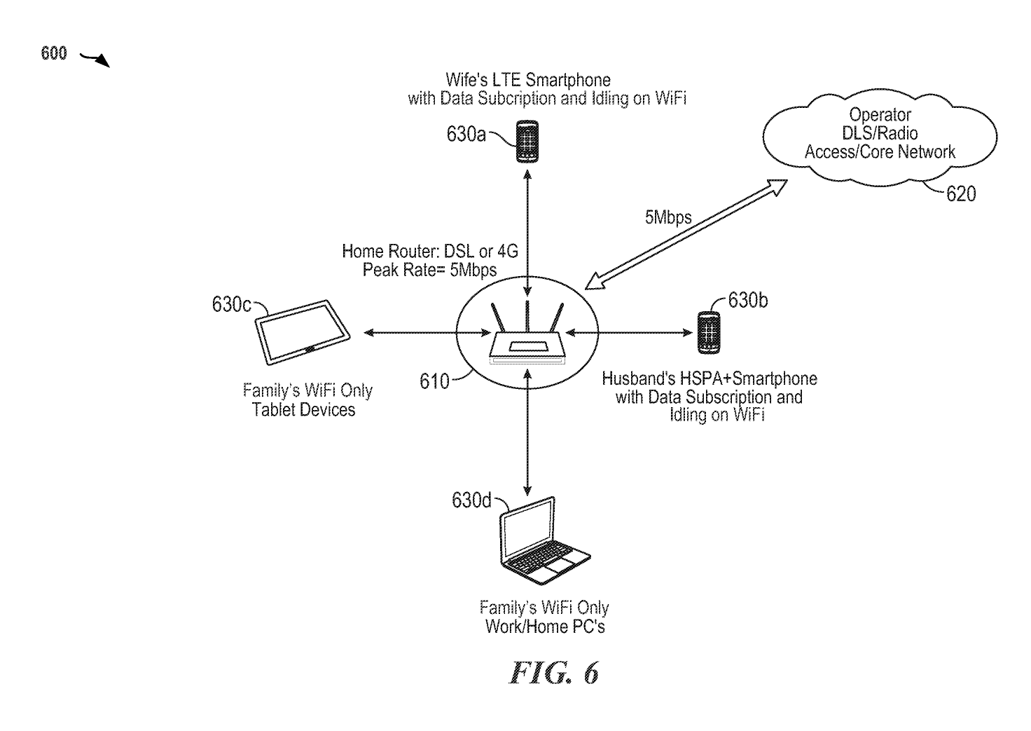

FIG. 6 illustrates an example of a home or workplace network 600 with multiple user devices each with LAN access (e.g., via WiFi) which use a single home router for WAN access. In this scenario, the single home router 610, which has 4G wireless access, DSL wired access, cable modem access, satellite backhaul access, fiber-to-home access or any other broadband access to an external network 620 (e.g., ISP access, core network access, Internet access, etc.), causes a user throughput bottleneck due to the limited WAN access throughput of the single home router. For example, the WAN access throughput may be limited to approximately 5 Mbps whereas the LAN access throughput may range from 100 to 1000 Mbps. Thus, for example, the multiple user devices 630a, 630b, 630c, 630d may be constrained by the limited WAN access, although some user devices may have non-utilized WAN access capability due to the network configuration shown or due to user inactivity on its LAN. Alternatively, in a different network configuration where a user device connects to both a WAN and a WLAN, if the user device is idle on the WAN, the user device may still share its WAN access with other user devices on the WLAN.

Alternatives to enhancing the user throughput is presented in the present disclosure to alleviate the WAN access throughput and peak data rate constraints. Also, alternatives are presented to provide protection against network outages with no or minimal changes to network hardware or standard protocols.

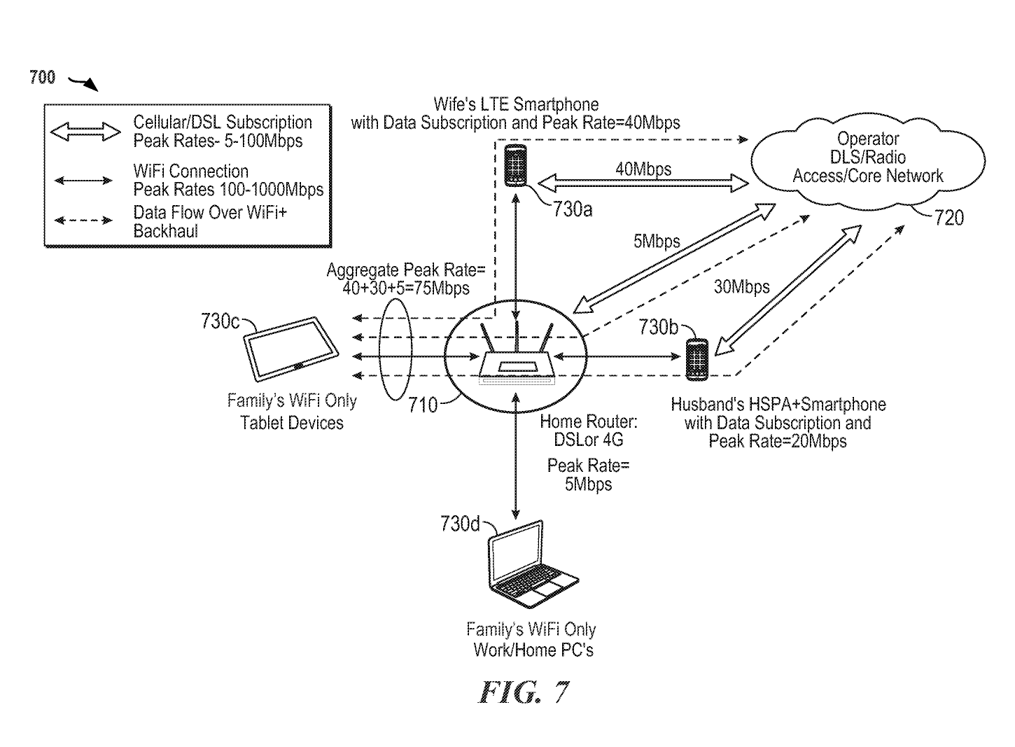

FIG. 7 illustrates a first example of a broadband subscription system 700 where additional WAN access throughput is attained by aggregating WAN access from various user devices 730a, 730b, 730c, 730d. In the example of FIG. 7, user de vices 730a, 730b are backhaul capable user devices. That is, they have a separate WAN access to an external network 720 (a.k.a., Operator DSL/Radio Access/Core Network) in addition to a baseline WAN access using a home router 710. For example, a first user device (e.g., wife's LTE smartphone 730a) may have a WAN access throughput of 40 Mbps and a second user device (e.g. husband's HSPA+ smartphone 730b) may have a WAN access throughput of 30 Mbps, resulting in an aggregate WAN access throughput of 75 Mbps (5+40+30=75 Mbps). As illustrated in FIG. 7, the user device 730c sends data to and receives data from the external network 720. The user device 730c is referred to as a legacy device.

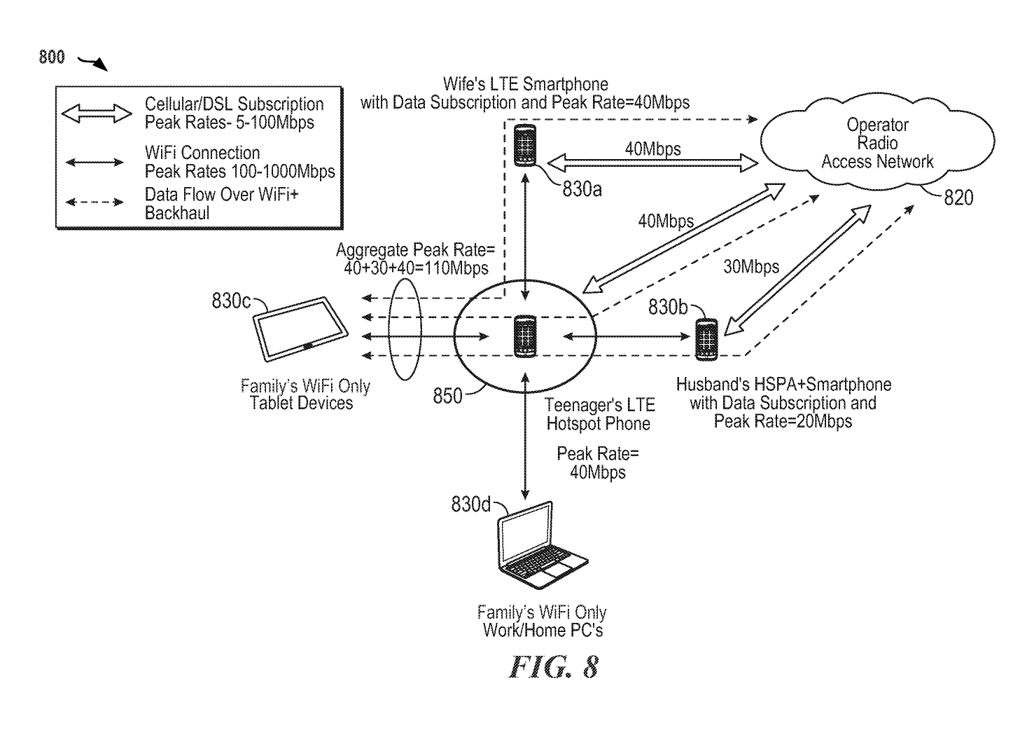

FIG. 8 illustrates a second example of a broadband subscription system 800 where additional WAN access throughput is attained by aggregating WAN access from various user devices 830a, 830b, 830c, 830d. In the example of FIG. 8, user devices 830a, 830b are backhaul capable user devices. That is, they have a separate WAN access to an external network 820 (a.k.a., Operator Radio Access Network). For example, a first user device (e.g., wife's LTE smartphone 830a) may have a WAN access throughput of 40 Mbps, a second user device (e.g., husband's HSPA+ smartphone 830b) may have a WAN access throughput of 30 Mbps, and a third user device (e.g., teenager's LTE hotspot phone 850) may have a WAN access throughput of 40 Mbps resulting in an aggregate WAN access throughput of 110 Mbps (40+30+40=110 Mbps). In the example illustrated in FIG. 8, the LAN (e.g., WiFi) may operate at a single frequency channel. In the example of FIG. 8, no separate router is required in the broadband subscription service. As illustrated in FIG. 8, the user device 830c sends data to and receives data from the external network 820. The user device 830c is referred to as a legacy device.

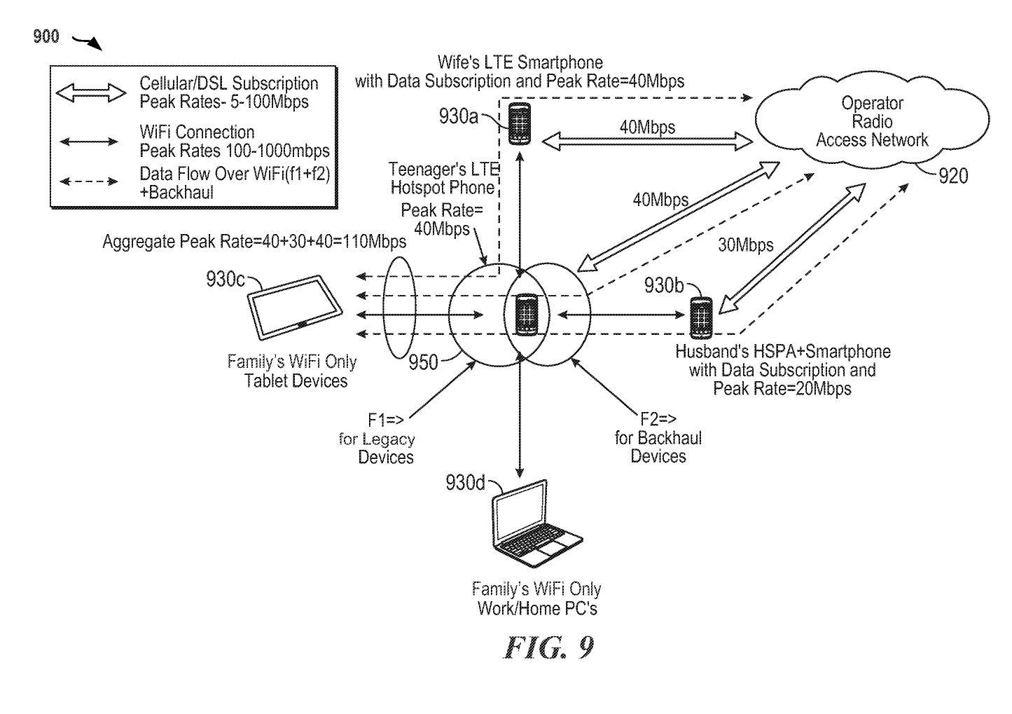

FIG. 9 illustrates a third example of a broadband subscription system 900 where additional WAN access throughput is attained by aggregating WAN access from various user devices 930a, 930b, 930c, 930d. In the example of FIG. 9, user devices 930a, 930b are backhaul capable user devices. That is, they have a separate WAN access to an external network 920 (a.k.a., Operator Radio Access Network). For example, a first user device (e.g., wife's LTE smartphone 930a) may have a WAN access throughput of 40 Mbps, a second user device (e.g., husband's HSPA+ smartphone 930b) may have a WAN access throughput of 30 Mbps, and a third user device (e.g., teenager's LTE hotspot phone 950) may have a WAN access throughput of 40 Mbps resulting in an aggregate WAN access throughput of 110 Mbps (40+30+40=110 Mbps). In the example illustrated in FIG. 9, the LAN (e.g., WiFi) may operate at two frequency channels, e.g., f1 for legacy user devices and f2 for backhaul capable user devices). In the example of FIG. 9, no separate router is required in the broadband subscription service. As illustrated in FIG. 9, the user device 930c sends data to and receives data from the external network 920. The user device 930c is referred to as a legacy device.

In various examples, the aggregation of broadband subscription services may be facilitated through the usage of at least two devices, for example, an aggregator device (e.g., the devices 710, 850, 950 shown in FIGS. 7, 8, 9, respectively, that are used as an aggregator) and one or more bridging devices (e.g., user devices 730a & 730b, 830a & 830b, and 930a & 930b of FIGS. 7, 8, 9, respectively).

In various examples, an aggregator device (a.k.a. “aggregator”) may discover all user devices in a subnet, where a home or workplace network may be partitioned into two subnets: one subnet for backhaul capable devices (i.e., WAN subnet) and another subnet for legacy devices without a broadband subscription service (i.e., LAN subnet). Being without a broadband subscription service means not having access to the external network. The subnet is a defined portion of home or workplace network. In a network content, “discover” means to determine network elements and/or services based on network monitoring by a network device.

The aggregator device (e.g., the devices 710, 850, 950 shown in FIGS. 7, 8, 9, respectively, that are used as an aggregator) may store a database of available or shared “data buckets” on a periodic (e.g., daily, weekly, monthly, etc.) basis per backhaul capable user device. The aggregator device may also serve as a proxy for all outgoing data requests. For example, the aggregator device may perform routing (e.g., smart routing) of data requests through selected backhaul capable user devices based on a required quality of service (QoS) and available “data buckets” or based on user data-usage patterns. The aggregator device may perform launching of a second hotspot frequency based on the available backhaul capable user devices and throughput. For example, the aggregator device may reside on a smart phone or WiFi router. The aggregator device may perform multi-link transmission control protocol (TCP) on behalf of a client to aggregate multiple backhaul links.

Smart routing is routing of data using criteria that may be predefined by a set of routing rules and/or by a user. Smart routing may include steps to select a route (i.e., interconnected series of network links) between a source (i.e., a sender) and a destination (i.e., a receiver). In some examples, smart routing may incorporate routing algorithms that determine an optimum route based on a set of criteria. In addition, smart routing may be dynamic (i.e., a function of time) and may be based on current traffic conditions. For example, current traffic conditions may be monitored by a device through traffic flow measurements and may be quantified by a set of network traffic parameters such as throughput, delay, delay jitter, packet loss statistics, buffer overflow, etc. In various examples, smart routing may be based on the mix or the load of backhaul capable devices and legacy devices.

In some examples, dynamic traffic assignment may be based on periodic traffic monitoring where network traffic parameters are quantified at a specific update rate. For example, periodic traffic monitoring may be performed once per second, once per 10 seconds, once per minute, etc.

A bridging device interconnects devices with an external network. For example, a bridging device may discover an aggregator device in the subnet. It may, for example, advertise available (e.g., on a daily, a weekly, or monthly basis, etc.) “data buckets”. The bridging device/bridge may bridge data requests coming from an aggregator device over a LAN (e.g., WiFi) to a WAN (e.g., wireless or wired WAN) interface. For example, the bridging device may use any cellular, satellite backhaul or wired technology and may use either a pre-paid subscription or post-paid subscription. In various examples, the bridging device may implement smart routing of data across the LAN (e.g., WiFi) or WAN (e.g., cellular or DSL) or both media.

In various examples, a bridging device may have a direct WAN connection to an external network without other intervening network devices in the home or workplace network. That is, the bridging device may be considered as an edge device which serves as a border between the home or workplace network and an external network. An edge device is a network device that is topologically at the boundary of the home or workplace network. The bridging device may implement a variety of WAN protocols which are compliant with different wireless or wired access technologies. In this manner, the home or workplace network is compatible with the external networks.

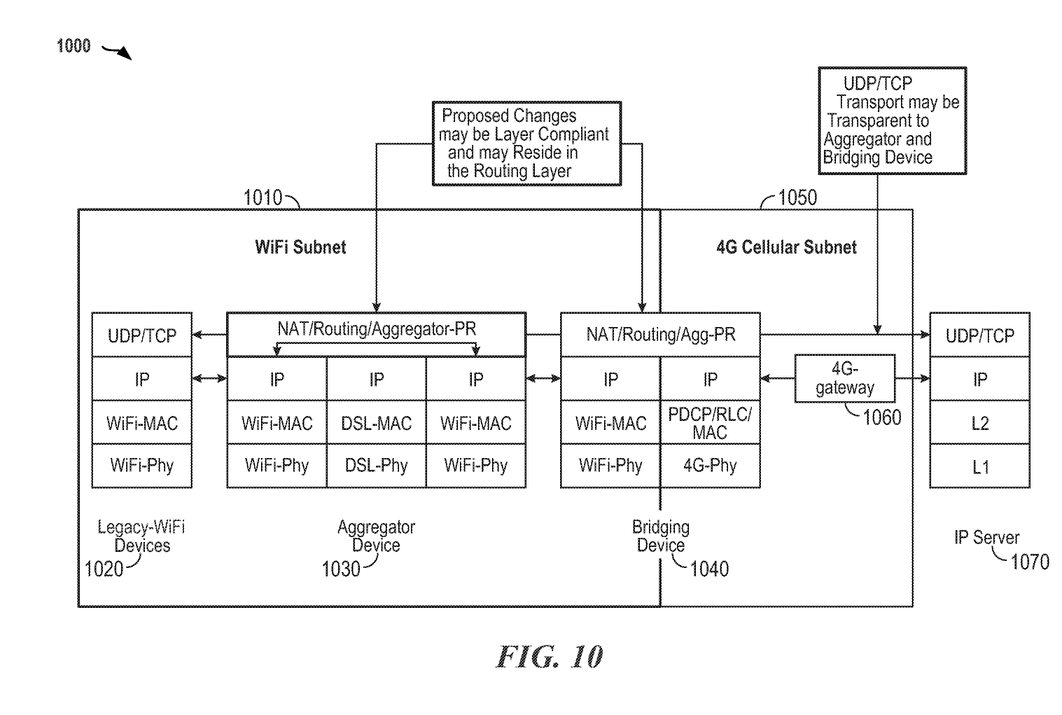

FIG. 10 illustrates an example protocol stack 1000 for cellular routing in broadband subscription aggregation in accordance with aspects of the present disclosure. As disclosed herein, subscription aggregation is the combination of individual broadband subscription services. A protocol stack is a schematic model for network communication showing transactions between peer entities as a set of layered structures. In the example protocol stack 1000, there are two subnets which comprise the home network: a LAN (e.g., WiFi) subnet 1010 and a WAN (e.g., 4G cellular) subnet 1050. For example, a legacy user device 1020 is shown on the left hand side which employs WiFi as its physical layer and media access control (MAC) layer. Furthermore, the legacy user device 1020 employs Internet Protocol (IP) as a network layer on top of the physical and MAC layers and either User Datagram Protocol (UDP) or Transmission Control Protocol (TCP) as a transport layer on top of the network layer. For example, the legacy user device does not have a WAN connection but may use its LAN connection to access the Internet via another device which has a WAN connection.

FIG. 10 also shows an aggregator device 1030 which also employs WiFi as its physical layer and MAC layer and IP as its network layer. In addition, the aggregator device 1030 includes an upper layer (e.g., on top of the IP layer) which includes network address translation (NAT), routing and aggregation functions to implement smart routing decisions between the legacy user device and a bridging device. NAT may be used to map one address to another address via a table lookup, for example.

The bridging device 1040 may bridge between the LAN subnet and the WAN subnet by including WiFi as its physical layer and MAC layer in the LAN (e.g., WiFi) subnet 1010 and by including 4G-PHY as its physical layer and packet data convergence protocol (PDCP)/radio link control (RLC)/MAC as its MAC layer in the WAN (e.g., 4G cellular) subnet 1050. For example, the bridging device 1040 includes IP as its network layer and an upper layer (e.g. on top of the IP layer) which includes network address translation (NAT), routing and aggregation functions to implement smart routing decisions between the two subnets: LAN (e.g., WiFi) subnet 1010 and WAN (e.g., 4G cellular) subnet 1050. Furthermore, the bridging device 1040 may connect to an external IP server 1070 via a 4G gateway 1060 at the IP layer and may include a TCP/UDP transport layer link to the external IP server. For example, the TCP/UDP transport layer link may be transparent to both the aggregator device 1030 and bridging device 1040. For example, the aggregator device 1030 may be a cable-modem router or a smartphone/WiFi router based on 5G, 4G, 3G, 2.5G, or other wireless technologies. For example, the bridging device 1040 may be a smartphone based on 5G, 4G, 3G, 2.5G, or other wireless technologies or a satellite phone. For example, the external IP server 1070 may be part of an external network.

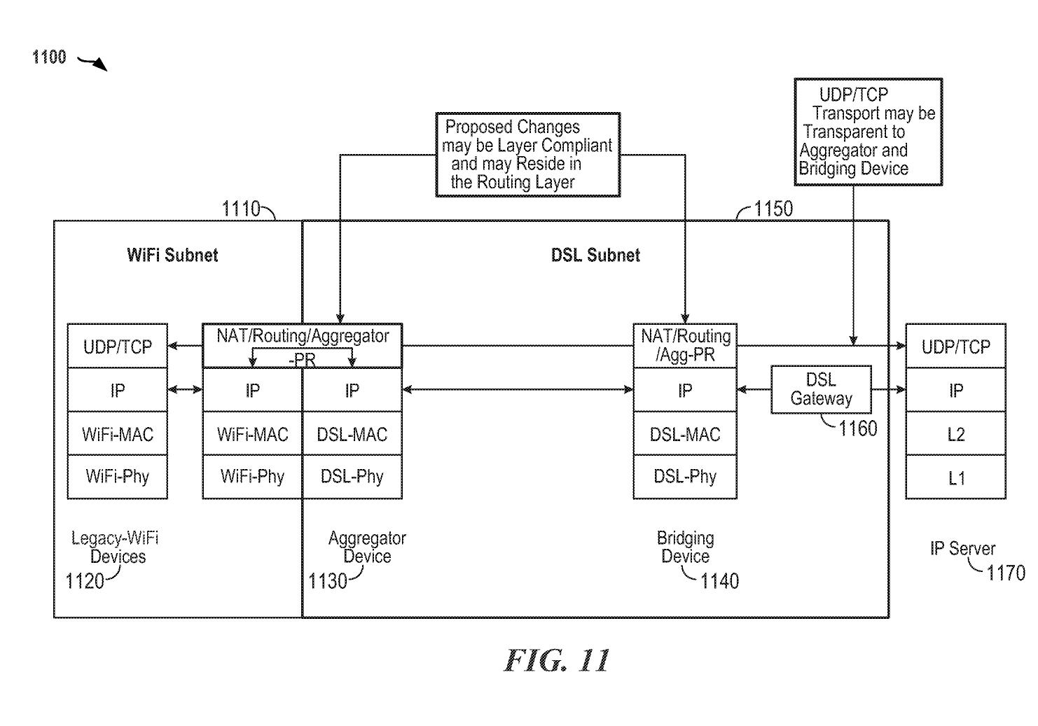

FIG. 11 illustrates an example protocol stack 1100 for Digital Subscriber Line (DSL) routing in broadband subscription aggregation in accordance with aspects of the present disclosure. In this example, there are two subnets which comprise the home network: a LAN (e.g., WiFi) subnet 1110 and a WAN (e.g., DSL) subnet 1150. For example, a legacy user device 1120 is shown on the left hand side which employs WiFi as its physical layer and media access control (MAC) layer. Furthermore, the legacy user device 1120 employs Internet Protocol (IP) as a network layer on top of the physical and MAC layers and either User Datagram Protocol (UDP) or Transmission Control Protocol (TCP) as a transport layer on top of the network layer. For example, the legacy user device 1120 does not have a WAN connection but may use its LAN connection to access another device which has a WAN connection.

FIG. 11 also shows an aggregator device 1130 which also employs WiFi as its physical layer and MAC layer on the LAN (e.g., WiFi) subnet 1110 and IP as its network layer. In addition, the aggregator device 1130 includes an upper layer (e.g. on top of the IP layer) which includes network address translation (NAT), routing and aggregation functions to implement smart routing decisions between the legacy user device 1120 and a bridging device 1140. For example, the aggregator device 1130 connects the LAN (e.g., WiFi) subnet 1110 and the WAN (e.g., DSL) subnet 1150 by including WiFi as its physical layer and MAC layer in the LAN (e.g., WiFi) subnet 1110 and by including DSL-PHY as its physical layer and DSL-MAC as its MAC layer in the WAN (e.g., DSL) subnet 1150.

For example, the bridging device 1140 includes IP as its network layer and an upper layer (e.g. on top of the IP layer) which includes network address translation (NAT), routing and aggregation functions to implement smart routing decisions. NAT may be used to map one address to another address via a table lookup, for example. Furthermore, the bridging device 1140 may connect to an external IP server 1170 via a DSL gateway 1160 at the IP layer and may include a TCP/UDP transport layer link to the external IP server 1170. For example, the TCP/UDP transport layer link may be transparent to both the aggregator device 1130 and bridging device 1140. For example, the aggregator device 1130 may be based on WiFi, WiMax, cellular-femto, Bluetooth, or other wireless technologies. In various examples, the aggregator device 1130 changes are implemented in the IP layer which is agnostic to the choice of backhaul or front-end technologies. For example, the external IP server 1170 may be part of an external network.

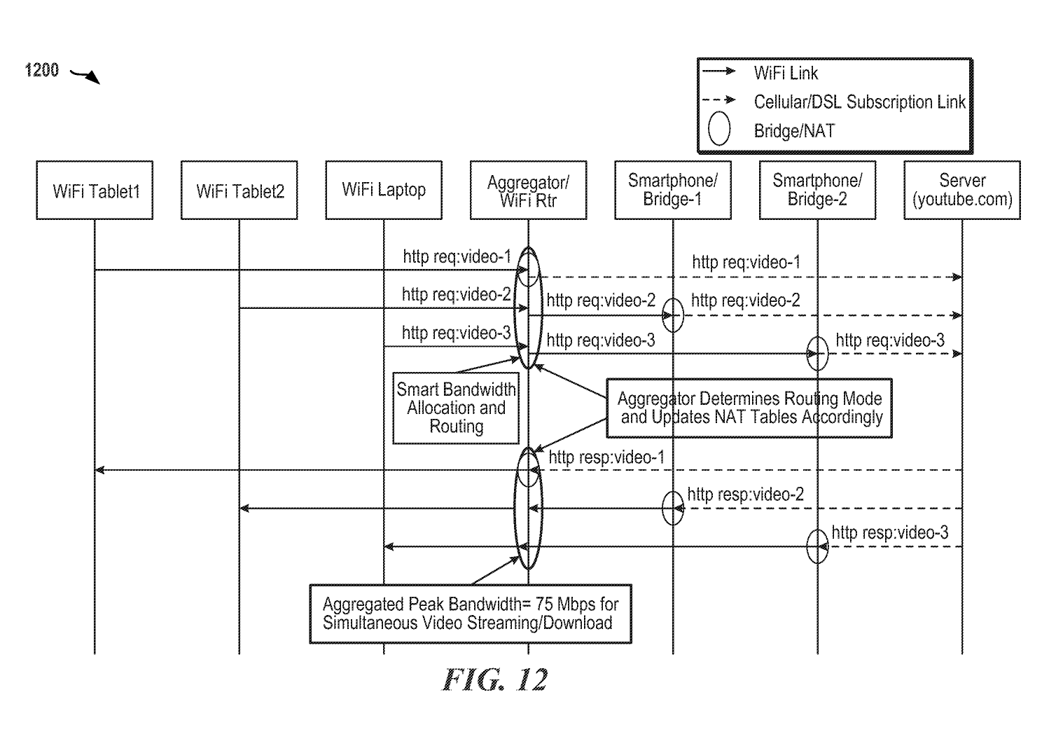

FIG. 12 illustrates an example data flow 1200 for a simultaneous download of video content by a plurality of LAN clients (i.e., user devices) in accordance with aspects of the present disclosure. In various examples, the video content may include multiple movies being downloaded by multiple user devices which may be WiFi devices. For example, the LAN may be based on WiFi. In FIG. 12, three LAN clients, WiFi Tablet 1, WiFi Tablet 2 and WiFi Laptop each make a “http request” for three video streams: video-1, video-2 and video-3, respectively, using the LAN. In various examples, the http request is a request using the Hypertext Transport Protocol. These http requests are intercepted by an aggregator device (e.g., a WiFi router) which performs smart bandwidth allocation and smart routing to various broadband subscription services (i.e., WAN connections). Smart bandwidth allocation is allocating bandwidth using criteria that may be predefined by a set of bandwidth allocation rules and/or by a user.

For example, the aggregator device distributes data requests over available broadband subscription services using a mapping strategy. In various examples, the mapping strategy may be based on a set of criteria predefined by a user. The aggregator device may also determine a routing mode and may also update network address translation (NAT) tables accordingly. In various examples, NAT may be invoked when data needs to cross-over from LAN to WAN; that is, a routing mode may be a deciding factor on use of certain bridge-devices for routing. A routing mode is a type of routing technology. Examples of routing modes may include: simple bridging/routing, multiport bridging/routing, learning or transparent bridging/routing, and source routing.

Subsequently, the request for video-1 is sent via a first WAN connection to an external network (e.g., youtube.com), the request for video-2 is sent using the LAN to a first bridging device (e.g., smartphone 1) which in turn sends the request for video-2 via a second WAN connection to the external network, and the request for video-3 is sent using the LAN to a second bridging device (e.g., smartphone 2) which in turn sends the request for video-3 via a third W AN connection to the external network.

For example, the external network responds to the http request with a “http response”. In FIG. 12, the external network may respond with a http response for video-1 via the first WAN connection to the aggregator device, a http response for video-2, via the second WAN connection to the first bridging device and a http response for video-3 via the third WAN connection to the second bridging device. Subsequently, each http response may be intercepted by the aggregator device which performs smart bandwidth allocation and smart routing. The aggregator device may also determine the routing mode and may also update network address translation (NAT) tables accordingly.

Next, the aggregator device may forward each http response to the respective LAN clients (i.e., user devices). For example, the aggregated peak bandwidth for simultaneous video streaming (download) may be around 75 Mbps using this aggregation technique. That is, the example flow diagram 1200 with the disclosed aggregation allows for faster user throughput to and from the external network(s).

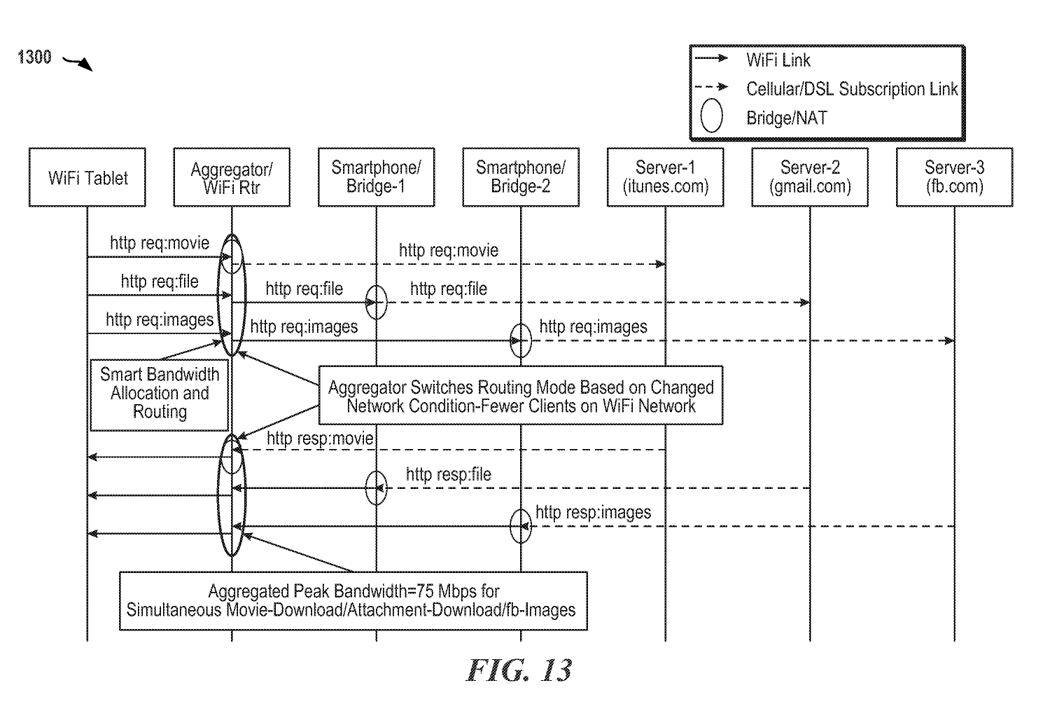

FIG. 13 illustrates an example data flow 1300 for a simultaneous download of video content, email attachment file and image file by a single LAN client (i.e., user device) in accordance with aspects of the present disclosure. For example, the LAN may be based on WiFi. In FIG. 13, a LAN client, the WiFi tablet, makes a “http request” for three distinct entities: video content, email attachment file and image file, respectively, using the LAN. In various examples, the http request is a request using the Hypertext Transport Protocol. These http requests are intercepted by an aggregator device (e.g., a WiFi router) which performs smart bandwidth allocation and smart routing to various broadband subscription services (i.e., WAN connections).

For example, the aggregator device distributes data requests over available broadband subscription services using a destination server to subscription link mapping strategy. The aggregator device may also determine the routing mode and may also update network address translation (NAT) tables accordingly.

Subsequently, the request for video content is sent via a first WAN connection to a first external network (e.g., itunes.com), the request for email attachment file is sent using the LAN to a first bridging device (e.g., smartphone 1) which in turn sends the request for email attachment file via a second WAN connection to a second external network (e.g., gmail.com), and the request for image file is sent using the LAN to a second bridging device (e.g., smartphone 2) which in turn sends the request for image file via a third WAN connection to a third external network (e.g., fb.com). For example, each external network responds to the http request with a “http response”.

In FIG. 13, each external network may respond with a http response for video content via the first WAN connection to the aggregator device, a http response for email attachment file via the second WAN connection to the first bridging device and to the aggregator device, and a http response for image file via the third WAN connection to the second bridging device and to the aggregator device. Subsequently, each http response may be intercepted by the aggregator device which performs smart bandwidth allocation and smart routing. The aggregator device may also determine the routing mode and may also update network address translation (NAT) tables accordingly. Next, the aggregator device may forward each http response to the LAN client (i.e., WiFi tablet). For example, the aggregated peak bandwidth for simultaneous data transfer (download) may be around 75 Mbps using this aggregation technique. That is, the example flow diagram 1300 with the disclosed aggregation allows for faster user throughput to and from the external network(s).

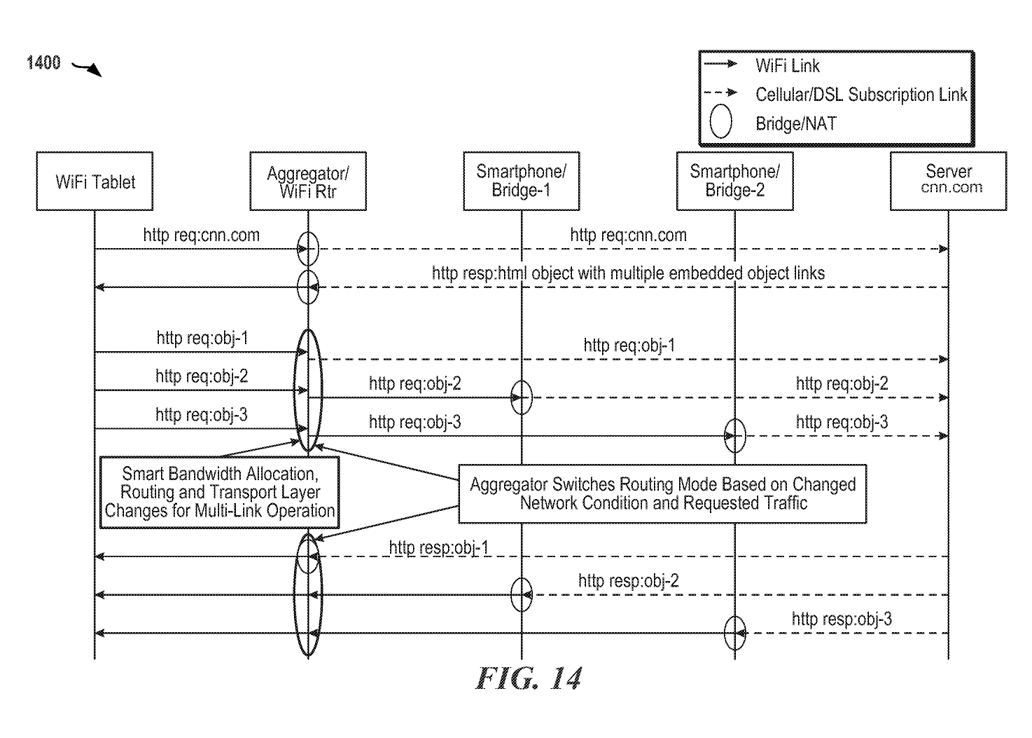

FIG. 14 illustrates an example data flow 1400 for a single connection over multiple broadband subscription services by a LAN client (e.g., WiFi tablet) in accordance with aspects of the present disclosure. For example, the LAN may be based on WiFi. In FIG. 14, the LAN client makes a “http request” to an external network (e.g., cnn.com), using the LAN. For example, the http request is a request using the Hypertext Transport Protocol. The http request is intercepted by an aggregator device (e.g., a WiFi router). Subsequently, the http request is sent via a first WAN connection to the external network. For example, the external network responds to the http request with a “http response”. In FIG. 14, the external network may respond with a http response via the first WAN connection to the aggregator device. For example, the http response may include a html object with multiple embedded object links which are then forwarded to the LAN client via the LAN.

Subsequently, the LAN client may send a plurality of http requests for each object to the aggregator device via the LAN. For example, the aggregator device may send a first http request for object-1 to the external network through a second WAN connection, a second http request for object-2 to the external network through a third WAN connection via a first bridging device (e.g. first smartphone), and a third http request for object-3 to the external network through a fourth WAN connection via a second bridging device. The aggregator device may perform smart bandwidth allocation, routing and transport layer changes for multi-link operation. For example, the aggregator device may switch the routing mode based on changed network conditions and requested traffic.

Next, the aggregator device may receive each corresponding http responses to the respective http requests For example, the aggregator device receives data responses over available broadband subscription services via http response for object-1 directly from the external network, via http response for object-2 through the first bridging device and via http response for object-3 though the second bridging device. The aggregator device may then forward the individual http responses to the LAN client. For example, the aggregator device may distribute data requests corresponding to a single connection over multiple broadband subscription services with appropriate transport layer proxy changes. That is, the example flow diagram 1400 with the disclosed aggregation allows for faster user throughput to and from the external network(s).

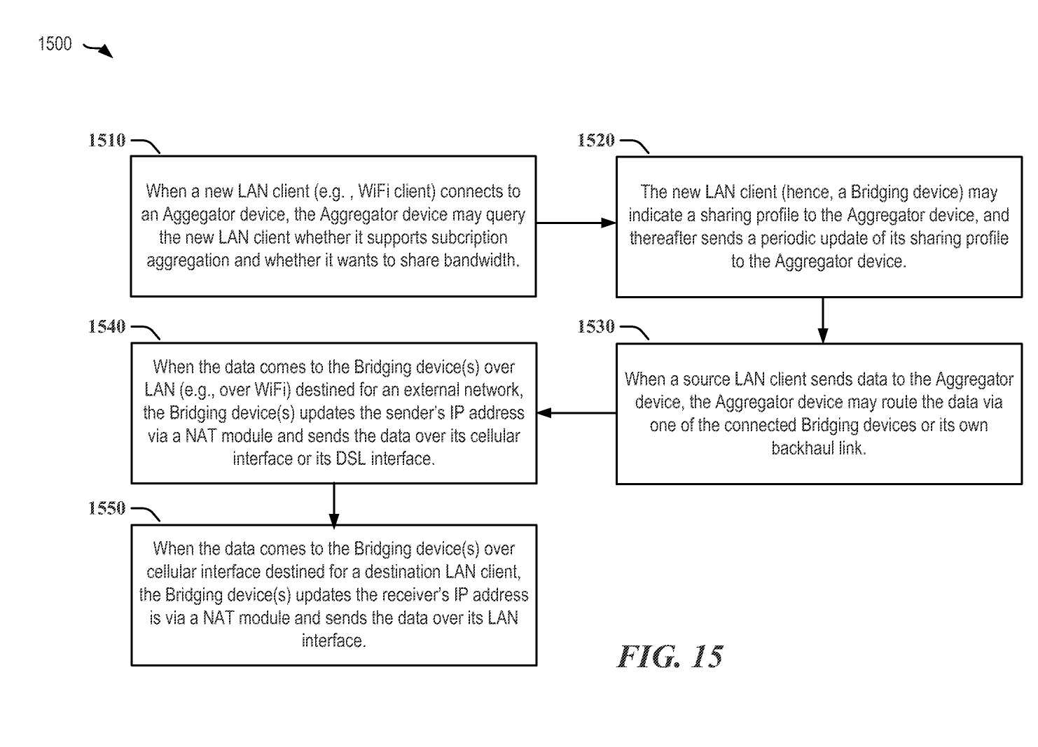

In various aspects, an aggregation and bridging protocol may be used to aggregate and/or bridge broadband subscription services in a home or workplace network. FIG. 15 illustrates an example aggregation and bridging protocol 1500 with interaction between an aggregator device (e.g., aggregator device 1030, 1130) and a bridging device (e.g., bridging device 1040, 1140) in accordance with aspects of the present disclosure. In various examples, an aggregator device discovers backhaul capable user devices in the home or workplace network. In a network content, “discovers” means to determine network elements and/or services based on network monitoring by a network device. For example, the aggregator device may collect information within a network to determine which user device(s) is backhaul capable. In various examples, a backhaul capable user device may have a WAN connection to an external network (e.g., the Internet). For example, the aggregator device may discover a list of user devices which are backhaul capable along with various network attributes (e.g., throughput, backhaul capacity or WAN bandwidth).

In block 1510, when a new LAN client (e.g., a WiFi client) connects to an aggregator device, the aggregator device may query the new LAN client whether it supports subscription aggregation and whether it wants to share its bandwidth. In the present disclosure, a WiFi client may be a device that uses WiFi (“WiFi device”). That is, the aggregator device may query the new LAN client when the new LAN client connects to a LAN access point. The query may ask the new LAN client if it is a backhaul capable user device which supports subscription aggregation and if it desires to share its WAN bandwidth with other clients. For example, the LAN may be based on WiFi and the LAN access point may be a WiFi access point. In some cases, the LAN access point may be the aggregator device. The new LAN client may be another user device.

In block 1520, the new LAN client (e.g., the WiFi Client) may indicate a sharing profile to the aggregator device. The sharing profile may include a list of WAN connection parameters. And, thereafter, the new LAN client may send a periodic update of its sharing profile to the aggregator device. That is, the aggregator device may receive a first receipt of a sharing profile from the new LAN client. In addition, the aggregator device may receive a periodic update of the sharing profile from the new LAN client after the first receipt of the sharing profile. In various examples, the list of WAN connection parameters for the new LAN client may include throughput, delay characteristic, jitter characteristic, scheduling information a billing cycle, a post-paid limit, a pre-paid data limit, a user-ordered data limit per day, an amount of bandwidth the new LAN client is willing to commit to sharing, one or more other WAN connection parameters, or a combination thereof. And, the list of WAN connection parameters may also include under what types of conditions the new LAN client is willing to commit to sharing its bandwidth. In various examples, the new LAN client may be a bridging device.

In block 1530, when a source LAN client sends data to the aggregator, device the aggregator device may route the data, via one or more of the connected bridging devices or through its own backhaul link (e.g., a cellular interface or a DSL interface) to the external network. That is, the aggregator device may route egress data from the source LAN client via one or more of the bridging devices and/or the aggregator device may route the data via its own backhaul link after the source LAN client sends the data traffic to the aggregator device. In various examples, the data destined for the external network may be referred to as egress data.

In various examples, the source LAN client generates the egress data. In various examples, the backhaul link may be a cellular interface (i.e., a cellular backhaul link) or a DSL interface (i.e., a DSL backhaul link), a cable-modem interface, a fiber-to-home interface, a satellite backhaul, or any other suitable backhaul link. The routing of egress data may involve the aggregation of one or more bridging devices and/or backhaul links in the egress direction (i.e., from the home or workplace network to the external network). In various examples, the source LAN client may be a legacy WiFi client.

In block 1540, when data, comes to the one or more bridging devices over LAN (e.g., over WiFi) destined for the external network in an egress direction which requires network address translation (NAT), the bridging device updates the sender IP address (i.e., the source IP address) via a NAT module and sends the data over its cellular interface or its DSL interface. In various examples, data destined for the external network in the egress direction may be referred to as egress data.

In block 1550, when data comes to the one or more bridging devices over cellular interface destined for a destination LAN client which requires network address translation (NAT), the one or more bridging devices updates the receiver IP address (i.e., the destination IP address) via a NAT module and sends the data over its LAN interface. In various examples, data destined for the destination LAN client may be referred to as ingress data. That is, the aggregator device may route the ingress data from the one or more bridging devices to the destination LAN client. Also, the aggregator device may use the aggregator device's backhaul link (bypassing the one or more bridging devices) to route the ingress data to the destination LAN client. And, in other examples, the combination of routing from the one or more bridging device and using the aggregator device's backhaul link for routing the ingress data may be used. The destination LAN client may be a consumer of the ingress data.

For example, the aggregation and/or bridging may employ multiple transmission control protocol (TCP) sessions to transport data from sender to destination in a reliable manner, but with latency due to the TCP handshaking steps. Alternatively, the aggregator device may employ multiple user datagram protocol (UDP) sessions to transport data from sender to destination in an unreliable, but low latency manner, due to the low overhead of UDP.

In addition, the aggregation may employ a single carrier frequency or multiple carrier frequencies on the LAN to transport data from one user device to another user device. Usage of multiple carrier frequencies may alleviate limited LAN throughput. For example, the aggregator device may implement a smart algorithm to switch from a single carrier frequency to multiple carrier frequencies on the LAN. The backhaul capable user devices may also have functionalities to trigger a switch to multiple carrier frequencies on the LAN as a function of traffic demand on the WAN.

The aggregator device may also employ multiple virtual local area networks (VLANs) to separate the LAN bandwidth between legacy user devices and backhaul capable user devices. A legacy user device in this context is a user device which uses only a LAN connection, without a WAN connection.

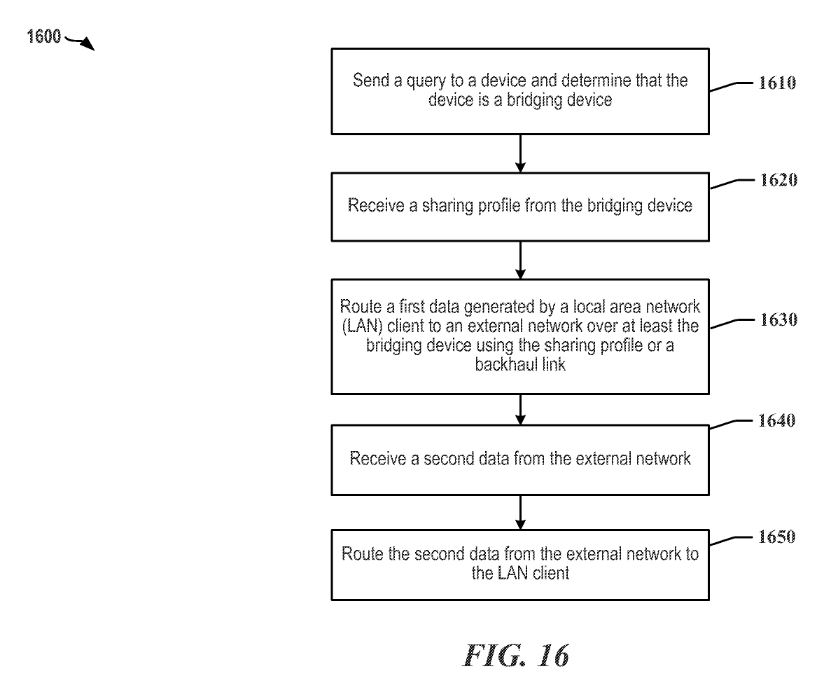

FIG. 16 illustrates a first example flow diagram 1600 for aggregating bandwidth in broadband subscription services in accordance with aspects of the present disclosure. In various aspects, an aggregator device may include an ingress module, a router module, a processor and/or an egress module configured to perform one or more steps disclosed in the flow diagram 1600. In block 1610, the aggregator device sends a query to a device and determines that the device is a bridging device. In various examples, a device is a bridging device if the device has access to a wide area network (WAN) and if the device will share its wide area network (WAN) bandwidth with another device. In various examples, the access to the WAN is either over a wireless interface (e.g., a cellular interface), a wired interface (e.g., a Digital Subscriber Line (DSL) interface), a cable-modem interface, a fiber-to-home interface, a satellite backhaul etc. The aggregator device may send the query over a local area network (LAN), for example, a WiFi network. In various examples, the egress module of the aggregator device is configured to perform the sending in block 1610. In various examples, an antenna coupled to the egress module may be used to perform the sending in block 1610.

In block 1620, the aggregator device receives a sharing profile from the bridging device. In various examples, the sharing profile includes one or more WAN connection parameters. The one or more WAN connection parameters may include a throughput, a delay characteristic, a jitter characteristic, a scheduling information, a billing cycle, a post-paid limit, a pre-paid data limit, a user-ordered data limit per day, an amount of bandwidth committed for sharing by the bridging device, one or more other WAN connection parameters, or a combination thereof. In various aspects, the aggregator device may receive one or more periodic updates of the sharing profile from the bridging device. In various examples, the sharing profile(s) are received by the aggregator device over a local area network (LAN), for example, over a WiFi network. In various examples, the sharing profile is received using a single earner frequency or multiple carrier frequencies. In various examples, the ingress module of the aggregator device is configured to perform the receiving in block 1620. In various examples, an antenna coupled to the ingress module may be used to perform the receiving in block 1620.

In block 1630, the aggregator device routes a first data generated by a local area network (LAN) client to an external network through (or over) at least the bridging device using the sharing profile or a backhaul link of the aggregator device. The aggregator device may route the first data using a single carrier frequency or multiple carrier frequencies. In various examples, the LAN client is a legacy client wherein the legacy client is not a backhaul compatible user device; that is without backhaul compatibility. In various example, the first data is an egress data and the external network is one of the following: Internet, a public data network or a private data, network. In various examples, the first data is a request data, for example, a http request. In various examples, the backhaul link may be a cellular interface (i.e., a cellular backhaul link), a DSL interface (i.e., a DSL backhaul link), a cable-modem interface, a fiber-to-home interface, a satellite backhaul, or any other suitable backhaul link. In various examples, the router module of the aggregator device is configured to perform the routing in block 1630.

In block 1640, the aggregator device receives a second data from the external network. In various examples, the aggregator device receives the second data through (or over) at least one of the bridging device using the sharing profile or a backhaul link of the aggregator device. In various examples, the second data is received in response to the first data. In various examples, the second data is an ingress data. In various examples, the second data is a response data, for example, a “http response”. In various examples, the backhaul link may be a cellular interface (i.e., a cellular backhaul link), a DSL interface (i.e., a DSL backhaul link), a cable-modem interface, a fiber-to-home interface, a satellite backhaul, or any other suitable backhaul link. In various examples, the ingress module of the aggregator device is configured to perform the receiving in block 1640. In various examples, an antenna coupled to the ingress module may be used to perform the receiving in block 1640.

In block 1650, the aggregator device routes the second data from the external network to the LAN client. In various examples, the aggregator device routes the second data over a local area network (LAN), for example, a WiFi network. The aggregator device may route the second data using a single carrier frequency or multiple carrier frequencies. In various examples, the routing module of the aggregator device is configured to perform the routing in block 1650.

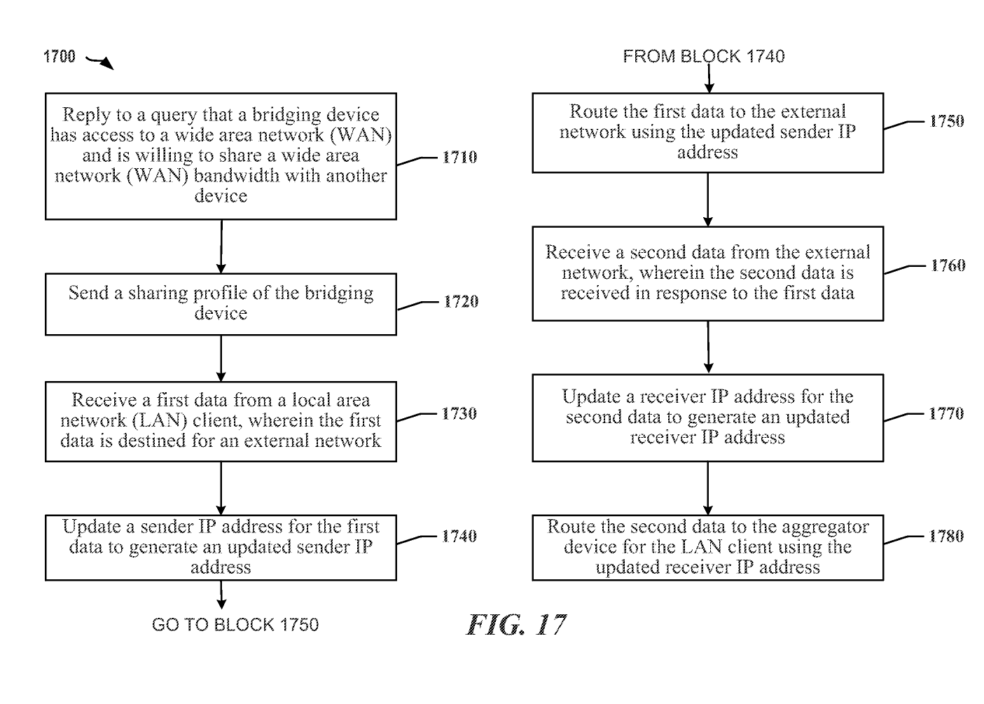

FIG. 17 illustrates a second example flow diagram 1700 for aggregating bandwidth in broadband subscription services in accordance with aspects of the present disclosure. In various aspects, a bridging device may include an ingress module, a router module, a processor and/or an egress module to perform one or more steps disclosed in the flow diagram 1700. In block 1710, a bridging device replies to a query that the bridging device has access to a wide area network (WAN) and is willing to share a wide area network (WAN) bandwidth with another device. In various examples, the query is sent by an aggregator device. In various examples, the query is sent by the aggregator device over a local area network (LAN), for example, a WiFi network. In various examples, the egress module of the bridging device is configured to perform the replying in block 1710. In various examples, an antenna coupled to the egress module may be used to perform the replying in block 1710.

In block 1720, the bridging device sends a sharing profile to an aggregator device, for example, sends at least one sharing profile of the bridging device. In various examples, the sharing profile includes one or more WAN connection parameters. The one or more WAN connection parameters may include a throughput, a delay characteristic, a jitter characteristic, a scheduling information, a billing cycle, a post-paid limit, a pre-paid data limit, a user-ordered data limit per day, an amount of bandwidth committed for sharing by the bridging device, one or more other WAN connection parameters, or a combination thereof. In various examples, the bridging device sends one or more periodic updates of the sharing profile. In various examples, the sharing profile is sent over a local area network (LAN), for example, over a WiFi network. In various examples, the sharing profile is sent using a single carrier frequency or multiple carrier frequencies. In various examples, the egress module of the bridging device is configured to perform the sending in block 1720. In various examples, an antenna coupled to the egress module may be used to perform the sending in block 1720.

In block 1730, the bridging device receives a first data from a local area network (LAN) client through the aggregator device, wherein the first data is destined for an external network. In various examples, the LAN client is a legacy client wherein the legacy client is not a backhaul compatible user device; that is without backhaul compatibility. In various example, the first, data is an egress data and the external network is one of the following: Internet, a public data network or a private data network. In various examples, the first data is a request data, for example, a http request. In various examples, the ingress module of the bridging device is configured to perform the receiving in block 1730. In various examples, an antenna coupled to the ingress module may be used to perform the receiving in block 1730.

In block 1740, the bridging device updates a sender IP address for the first data to generate an updated sender IP address. In various examples, the sender IP address is a source IP address and is updated using a network address translation (NAT). In various examples, the sender IP address corresponds to the LAN client. In various examples, the routing module of the bridging device is configured to perform the updating in block 1740.

In block 1750, the bridging device routes the first data to the external network using the updated sender IP address. In various examples, the bridging device routes the first data over a wide area network (WAN) or over a backhaul link of the bridging device. In various examples, the backhaul link may be a cellular interface (i.e., a cellular backhaul link), a DSL interface (i.e., a DSL backhaul link), a cable-modem interface, a fiber-to-home interface, a satellite backhaul, or any other suitable backhaul link. The bridging device may route the first data using a single carrier frequency or multiple carrier frequencies. In various examples, the routing module of the bridging device is configured to perform the routing in block 1750.

In block 1760, the bridging device receives a second data from the external network. In various examples, the second data is received in response to the first data. In various examples, the second data is an ingress data. In various examples, the bridging device receives the second data over a wireless WAN, for example, a cellular network. In various examples, the bridging device receives the second data over a wired WAN, for example, a Digital Subscriber Line (DSL) network. In other examples, the bridging device receives the second data over the backhaul link of the bridging device. In various examples, the ingress module of the bridging device is configured to perform the receiving in block 1760.

In block 1770, the bridging device updates a receiver IP address for the second data to generate an updated receiver IP address. In various examples, the receiver IP address is a destination IP address and is updated using a network address translation (NAT). In various examples, the receiver IP address corresponds to the LAN client. In various examples, the routing module of the bridging device is configured to perform the updating in block 17470.

In block 1780, the bridging device routes the second data to the aggregator device for the LAN client using the updated receiver IP address. In various examples, the bridging device routes the second data over a local area network (LAN), for example, over a WiFi network. The bridging device may route the second data using a single carrier frequency or multiple carrier frequencies. In various examples, the routing module of the bridging device is configured to perform the routing in block 1780.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

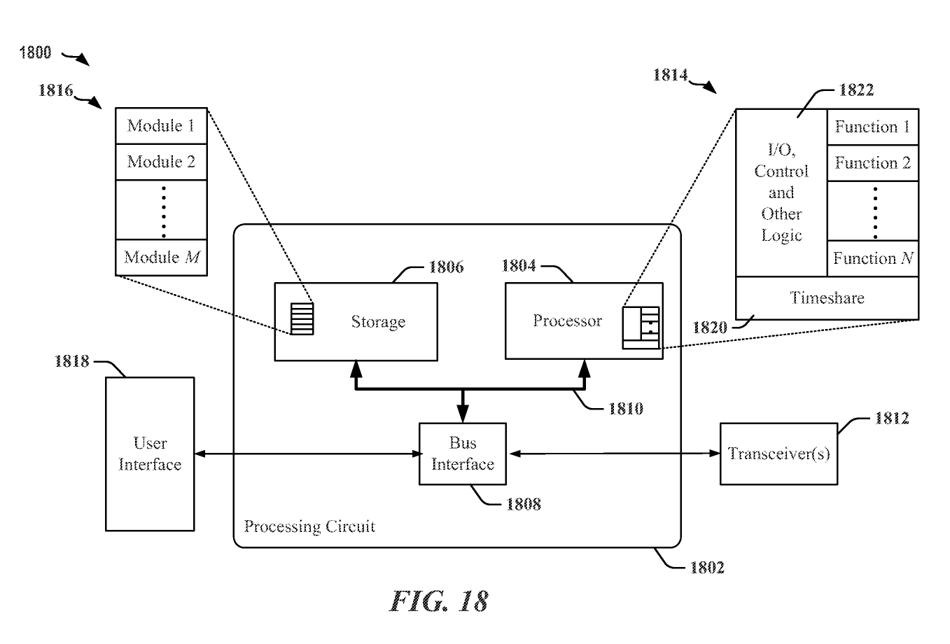

FIG. 18 is a conceptual diagram 1800 illustrating a simplified example of a hardware implementation for an apparatus employing a processing circuit 1802 that may be configured to perform one or more functions in accordance with aspects of the present disclosure. In accordance with various aspects of the disclosure, an element, or any portion of an element, or any combination of elements as disclosed herein may be implemented utilizing the processing circuit 1802. The processing circuit 1802 may include one or more processors 1804 that are controlled by some combination of hardware and software modules. Examples of processors 1804 include microprocessors, microcontrollers, digital signal processors (DSPs), field programmable gate arrays (FPGAs), programmable logic devices (PLDs), state machines, sequencers, gated logic, discrete hardware circuits, and other suitable hardware configured to perform the various functionality described throughout this disclosure. The one or more processors 1804 may include specialized processors that perform specific functions, and that may be configured, augmented or controlled by one of the software modules 1816. In various aspects, the software modules 1816 may include an egress module, an ingress module and/or a routing module for performing one or more of the features and/or steps in the flow diagrams of FIGS. 16-17.

The one or more processors 1804 may be configured through a combination of software modules 1816 loaded during initialization, and further configured by loading or unloading one or more software modules 1816 during operation.

In the illustrated example, the processing circuit 1802 may be implemented with a bus architecture, represented generally by the bus 1810. The bus 1810 may include any number of interconnecting buses and bridges depending on the specific application of the processing circuit 1802 and the overall design constraints. The bus 1810 links together various circuits including the one or more processors 1804, and storage 1806. Storage 1806 may include memory devices and mass storage devices, and may be referred to herein as computer-readable storage media and/or processor-readable storage media. The bus 1810 may also link various other circuits such as timing sources, timers, peripherals, voltage regulators, and power management circuits. A bus interface 1808 may provide an interface between the bus 1810 and one or more transceivers 1812. A transceiver 1812 may be provided for each networking technology supported by the processing circuit. In some instances, multiple networking technologies may share some or all of the circuitry or processing modules found in a transceiver 1812. Each transceiver 1812 provides a means for communicating with various other apparatus over a transmission medium. Depending upon the nature of the apparatus, a user interface 1818 (e.g., keypad, display, speaker, microphone, joystick) may also be provided, and may be communicatively coupled to the bus 1810 directly or through the bus interface 1808.

A processor 1804 may be responsible for managing the bus 1810 and for general processing that may include the execution of software stored in a computer-readable storage medium that may include the storage 1806. In this respect, the processing circuit 1802, including the processor 1804, may be used to implement any of the methods, functions and techniques disclosed herein. The storage 1806 may be used for storing data that is manipulated by the processor 1804 when executing software, and the software may be configured to implement any one of the methods disclosed herein.

One or more processors 1804 in the processing circuit 1802 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1806 or in an external computer-readable storage medium. The external computer-readable storage medium and/or storage 1806 may include a non-transitory computer-readable storage medium. A non-transitory computer-readable storage medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable storage medium and/or storage 1806 may also include, by way of example, a carrier wave, a transmission line, and any other suitable medium for transmitting software and/or instructions that may be accessed and read by a computer. Computer-readable storage medium and/or the storage 1806 may reside in the processing circuit 1802, in the processor 1804, external to the processing circuit 1802, or be distributed across multiple entities including the processing circuit 1802. The computer-readable storage medium and/or storage 1806 may be embodied in a computer program product. By way of example, a computer program product may include a computer-readable storage medium in packaging materials. Those skilled in the art will recognize how best to implement the described functionality presented throughout this disclosure depending on the particular application and the overall design constraints imposed on the overall system.

The storage 1806 may maintain software maintained and/or organized in loadable code segments, modules, applications, programs, etc., which may be referred to herein as software modules 1816. Each of the software modules 1816 may include instructions and data that, when installed or loaded on the processing circuit 1802 and executed by the one or more processors 1804, contribute to a run-time image 1814 that controls the operation of the one or more processors 1804. When executed, certain instructions may cause the processing circuit 1802 to perform functions in accordance with certain methods, algorithms and processes described herein. In various aspects, each of the functions is mapped to the features and/or steps disclosed in one or more blocks of FIGS. 16 and 17.

Some of the software modules 1816 may be loaded during initialization of the processing circuit 1802, and these software modules 1816 may configure the processing circuit 1802 to enable performance of the various functions disclosed herein. In various aspects, each of the software modules 1816 is mapped to the features and/or steps disclosed in one or more blocks of FIGS. 16 and 17. For example, some software modules 1816 may configure internal devices and/or logic circuits 1822 of the processor 1804, and may manage access to external devices such as the transceiver 1812, the bus interface 1808, the user interface 1818, timers, mathematical coprocessors, and so on. The software modules 1816 may include a control program and/or an operating system that interacts with interrupt handlers and device drivers, and that controls access to various resources provided by the processing circuit 1802. The resources may include memory, processing time, access to the transceiver 1812, the user interface 1818, and so on.

One or more processors 1804 of the processing circuit 1802 may be multifunctional, whereby some of the software modules 1816 are loaded and configured to perform different functions or different instances of the same function. The one or more processors 1804 may additionally be adapted to manage background tasks initiated in response to inputs from the user interface 1818, the transceiver 1812, and device drivers, for example. To support the performance of multiple functions, the one or more processors 1804 may be configured to provide a multitasking environment, whereby each of a plurality of functions is implemented as a set of tasks serviced by the one or more processors 1804 as needed or desired. In various examples, the multitasking environment may be implemented utilizing a timesharing program 1820 that passes control of a processor 1804 between different tasks, whereby each task returns control of the one or more processors 1804 to the timesharing program 1820 upon completion of any outstanding operations and/or in response to an input such as an interrupt. When a task has control of the one or more processors 1804, the processing circuit is effectively specialized for the purposes addressed by the function associated with the controlling task. The timesharing program 1820 may include an operating system, a main loop that transfers control on a round-robin basis, a function that allocates control of the one or more processors 1804 in accordance with a prioritization of the functions, and/or an interrupt driven main loop that responds to external events by providing control of the one or more processors 1804 to a handling function. In various aspects, the functions depicted as Function 1 through Function N in the run-time image 1814 may include one or more of the features and/or steps disclosed in the flow diagrams of FIGS. 16-17.

In various examples, the methods of flow diagrams 1600 and 1700 may be implemented by one or more of the exemplary systems illustrated in FIGS. 1, 2, 3, 4, 5, and 18. In various examples, the methods of flow diagrams 1600 and 1700 may be implemented by any other suitable apparatus or means for carrying out the described functions.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more,” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b: a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method for aggregating bandwidth in broadband subscription services comprising:
sending a query to a device and determining that the device is a bridging device;
receiving a sharing profile from the bridging device; and
routing a first data generated by a local area network (LAN) client to an external network over at least the bridging device using the sharing profile or over a backhaul link.

2. The method of claim 1, further comprising:
receiving a second data from the external network over at least the bridging device using the sharing profile or over the backhaul link, wherein the second data is received in response to the first data; and
routing the second data to the LAN client.

3. The method of claim 2, wherein the LAN client is a legacy client without backhaul compatibility.

4. The method of claim 2, wherein the first data is a request data and the second data is a response data.

5. The method of claim 1, wherein the external network is one of the following: Internet, a public data network or a private data network.

6. The method of claim 1, further comprising determining that the device is the bridging device if the device has an access to a wide area network (WAN) and the device will share a wide area network (WAN) bandwidth with another device.

7. The method of claim 6, wherein the access to the WAN is either over a cellular interface or a Digital Subscriber Line (DSL) interface.

8. The method of claim 1, wherein the query is sent over a local area network (LAN).

9. The method of claim 8, wherein the LAN is a WiFi network.

10. The method of claim 1, wherein the sharing profile includes one or more of: a throughput, a delay characteristic, a jitter characteristic, a scheduling information, a billing cycle, a post-paid limit, a pre-paid data limit, a user-ordered data limit per day, or an amount of bandwidth committed for sharing by the bridging device.

11. The method of claim 10, wherein the sharing profile is received over a local area network (LAN).

12. The method of claim 1, wherein the backhaul link is one of the following: a cellular interface, a Digital Subscriber Line (DSL) interface, a cable-modem interface, a fiber-to-home interface, or a satellite backhaul.

13. A method for aggregating bandwidth in broadband subscription services comprising:
replying to a query that a bridging device has access to a wide area network (WAN) and is willing to share a wide area network (WAN) bandwidth with another device;
sending at least one sharing profile of the bridging device;
receiving a first data from a local area network (LAN) client, wherein the first data is destined for an external network:
updating a sender IP address for the first data, to generate an updated sender IP address; and
routing the first data to the external network using the updated sender IP address.

14. The method of claim 13, further comprising:
receiving a second data from the external network, wherein the second data is received in response to the first data;
updating a receiver IP address for the second data to generate an updated receiver IP address; and
routing the second data using the updated receiver IP address.

15. The method of claim 14, further comprising updating the receiver IP address using a network address translation (NAT).

16. The method of claim 14, wherein the external network is one of the following: Internet, a public data network or a private data network.

17. The method of claim 13, further comprising updating the sender IP address using a network address translation (NAT).

18. The method of claim 13, further comprising sending the at least one sharing profile over a local area network (LAN).

19. The method of claim 18, wherein the at least one sharing profile includes one or more of: a throughput, a delay characteristic, a jitter characteristic, a scheduling information, a billing cycle, a post-paid limit, a pre-paid data limit, a user-ordered data limit per day, or and an amount of bandwidth committed for sharing by the bridging device.

20. An apparatus for aggregating bandwidth in broadband subscription services comprising:
means for sending a query to a device and determining that the device is a bridging device;
means for receiving a sharing profile from the bridging device; and
means for routing a first data, generated by a local area network (LAN) client to an external network over at least the bridging device using the sharing profile or over a backhaul link.

21. The apparatus of claim 20, further comprising:
means for receiving a second data from the external network over at least the bridging device using the sharing profile or over the backhaul link, wherein the second data is received in response to the first data; and
means for routing the second data to the LAN client.

22. An apparatus for aggregating bandwidth in broadband subscription services comprising:
means for replying to a query that a bridging device has access to a wide area network (WAN) and is willing to share a wide area network (WAN) bandwidth with another device;
means for sending at least one sharing profile of the bridging device;
means for receiving a first data from a local area network (LAN) client, wherein the first data is destined for an external network;
means for updating a sender IP address for the first data to generate an updated sender IP address; and
means for routing the first data to the external network using the updated sender IP address.

23. The apparatus of claim 22, further comprising:
means for receiving a second data from the external network, wherein the second data is received in response to the first data;
means for updating a receiver IP address for the second data to generate an updated receiver IP address; and
means for routing the second data using the updated receiver IP address.
